(19) United States
(12) Patent Application Publication
(10) Pub. No.: US 2025/0363693 A1
(43) Pub. Date: Nov. 27, 2025

(54) ELECTRONIC DEVICE FOR GENERATING IMAGE AND METHOD FOR CONTROLLING THE SAME

(71) Applicant: Samsung Electronics Co., Ltd., Suwon-si, Gyeonggi-do (KR)

(72) Inventors: Seohee KIM, Suwon-si (KR); Donghee KANG, Suwon-si (KR)

(21) Appl. No.: 19/203,805

(22) Filed: May 9, 2025

Related U.S. Application Data
(63) Continuation of application No. PCT/KR2025/006277, filed on May 9, 2025.

(30) Foreign Application Priority Data
May 27, 2024 (KR) 10-2024-0068853
Jun. 11, 2024 (KR) 10-2024-0075944

(51) Int. Cl. G06T 11/60

(52) U.S. Cl. CPC G06T 11/60

(57) ABSTRACT

An electronic device is provided. The electronic device includes memory storing one or more computer programs, a display, and one or more processors communicatively coupled to the memory and the display, wherein the one or more computer programs include computer-executable instructions that, when executed by the one or more processors individually or collectively, cause the electronic device to display an execution screen of a message application, extract at least one keyword text based on conversation information with history displayed through the execution screen, based on receiving a user input for generating an image displayable on the execution screen, identify an image corresponding to the at least one keyword text among a plurality of images stored in the memory, obtain at least one first layer based on the identified image, obtain at least one second layer based on at least one of the conversation information, the at least one keyword text, or information related to the identified image, and generate the image by overlapping the at least one first layer and the at least one second layer.

### CROSS-REFERENCE TO RELATED APPLICATION(S)

This application is a continuation application, claiming priority under § 365 (c), of an International application No. PCT/KR2025/006277, filed on May 9, 2025, which is based on and claims the benefit of a Korean patent application number 10-2024-0068853, filed on May 27, 2024, in the Korean Intellectual Property Office, and of a Korean patent application number 10-2024-0075944, filed on Jun. 11, 2024, in the Korean Intellectual Property Office, the disclosure of each of which is incorporated by reference herein in its entirety.

### TECHNICAL FIELD

The disclosure relates to an electronic device configured to generate images and a method for controlling the same.

### BACKGROUND ART

Various services and additional functions provided through electronic devices, for example, portable electronic devices such as smartphones, are gradually increasing. In order to increase the usability of such electronic devices and to satisfy various user demands, communication service providers or electronic device manufacturers are competitively developing electronic devices to provide various functions and to be differentiated from other competitors. Accordingly, the level of various functions provided through electronic devices is gradually increasing.

In addition, electronic devices provide various graphic user interfaces (GUIs) to interact with users through displays.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic device configured to generate images and a method for controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, a display, and one or more processors communicatively coupled to the memory and the display, wherein the one or more computer programs further include computer-executable instructions that, when executed by the one or more processors individually or collectively, cause the electronic device to display an execution screen of a message application, extract at least one keyword text based on conversation information with history displayed through the execution screen, based on receiving a user input for generating an image displayable on the execution screen, identify an image corresponding to the at least one keyword text among a plurality of images stored in the memory, obtain at least one first layer based on the identified image, obtain at least one second layer based on at least one of the conversation information, the at least one keyword text, or information related to the identified image, and generate the image by overlapping the at least one first layer and the at least one second layer.

In accordance with another aspect of the disclosure, a method for controlling an electronic device is provided. The method includes displaying an execution screen of a message application, extracting at least one keyword text based on conversation information with history displayed through the execution screen, based on receiving a user input for generating an image displayable on the execution screen, identifying an image corresponding to the at least one keyword text among a plurality of images stored in memory of the electronic device, obtaining at least one first layer based on the identified image, obtaining at least one second layer based on at least one of the conversation information, the at least one keyword text, or information related to the identified image, and generating the image by overlapping the at least one first layer and the at least one second layer.

In accordance with another aspect of the disclosure, one or more non-transitory computer-readable recording media storing one or more computer programs including computer-executable instructions that, when executed by one or more processors of an electronic device individually or collectively cause the electronic device to perform operations are provided. The operations include displaying an execution screen of a message application, extracting at least one keyword text based on conversation information displayed through the execution screen, based on receiving a user input for generating an image displayable on the execution screen, identifying an image corresponding to the at least one keyword text among a plurality of images stored in the memory, obtaining at least one first layer based on the identified image, obtaining at least one second layer based on at least one of the conversation information, the at least one keyword text, or information related to the identified image, and generating the image by overlapping the at least one first layer and the at least one second layer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which.

FIG. 1 is a block diagram of an electronic device in a network environment according to an embodiment of the disclosure;

FIG. 2 is a flowchart illustrating operations in which an electronic device generates an image according to an embodiment of the disclosure;

FIG. 3A illustrates an operation in which an electronic device generates an image, based on conversation information according to an embodiment of the disclosure;

FIG. 3B illustrates an operation in which an electronic device generates an image, based on conversation information according to an embodiment of the disclosure;

FIG. 4 is a flowchart illustrating operations in which an electronic device generates a configured number of layers, based on conversation information, thereby generating an image according to an embodiment of the disclosure;

FIG. 5 is a flowchart illustrating operations in which an electronic device determines the number of layers, based on conversation information, and generates the determined number of layers, thereby generating an image according to an embodiment of the disclosure;

FIG. 6 illustrates an operation in which an electronic device generates an image, based on generative artificial intelligence (AI) according to an embodiment of the disclosure;

FIG. 7 is a flowchart illustrating a system for generating an image, based on conversation information, according to an embodiment of the disclosure;

FIG. 8 illustrates an operation in which an electronic device generates an image by using multiple layers generated based on conversation information according to an embodiment of the disclosure;

FIG. 9 is a flowchart illustrating operations in which an electronic device generates multiple layers, based on conversation information according to an embodiment of the disclosure;

FIG. 10 illustrates operations in which an electronic device generates multiple layers, based on conversation information according to an embodiment of the disclosure;

FIG. 11 illustrates operations in which an electronic device generates multiple layers, based on conversation information according to an embodiment of the disclosure;

FIG. 12 illustrates operations in which an electronic device generates multiple layers, based on conversation information according to an embodiment of the disclosure;

FIG. 13A illustrates an operation in which an electronic device generates a sub-layer, based on color information of an image extracted based on conversation information according to an embodiment of the disclosure;

FIG. 13B illustrates an operation in which an electronic device arranges an object of a sub-layer, based on an object of an image extracted based on conversation information according to an embodiment of the disclosure;

FIG. 14 illustrates an operation in which an electronic device displays a generated image on the full screen according to an embodiment of the disclosure;

FIG. 15 illustrates an operation in which an electronic device displays a generated image on the full screen according to an embodiment of the disclosure;

FIG. 16 illustrates an operation in which an electronic device modifies a generated image according to an embodiment of the disclosure;

FIG. 17 illustrates an operation in which an electronic device generates an image, based on an image selected by a user input according to an embodiment of the disclosure;

FIG. 18 illustrates an operation in which an electronic device modifies a generated image, based on an image selected by a user input according to an embodiment of the disclosure;

FIG. 19A illustrates an operation in which an electronic device generates an image, based on an image captured through a camera application, or a stored image according to an embodiment of the disclosure; and

FIG. 19B illustrates an operation in which an electronic device generates an image, based on an image captured through a camera application, or a stored image according to an embodiment of the disclosure.

The same reference numerals are used to represent the same elements throughout the drawings.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

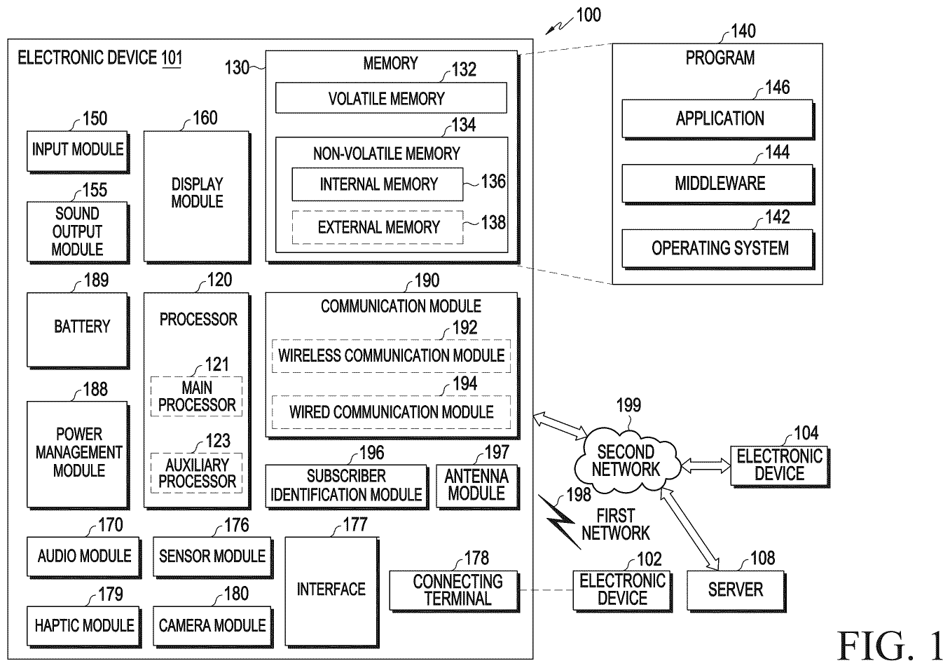

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IM SI)) stored in the subscriber identification module 196.

The wireless communication module 192 may support a 5G network, after a 4G network, and next-generation communication technology, e.g., new radio (NR) access technology. The NR access technology may support enhanced mobile broadband (eM BB), massive machine type communications (mM TC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eM BB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

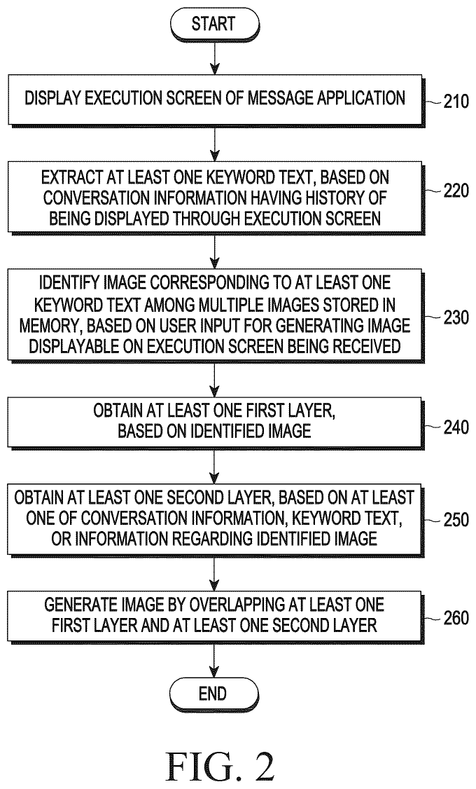

FIG. 2 is a flowchart illustrating operations in which an electronic device generates an image according to an embodiment of the disclosure.

Referring to FIG. 2, in operation 210, the electronic device (e.g., the electronic device 101 in FIG. 1 or the processor 120 in FIG. 1) may display an execution screen of a message application.

The message application may have already been stored in the memory of the electronic device when the electronic device was shipped, or may has been downloaded and installed by a user input.

The electronic device may display an execution screen of a message application, based on a user input (e.g., a touch) for executing the message application. The execution screen of the message application may include a chatting window including the content of a conversation with a specific counterpart.

In operation 220, the electronic device may extract at least one keyword text, based on conversation information having a history of being displayed through an execution screen. The electronic device may extract at least one keyword text not only from conversation information currently displayed on the display (e.g., the display module 160 in FIG. 1), but also from conversation information which has previously been displayed, but is not displayed on the display as new conversation information is input. For example, the electronic device may extract at least one keyword text from conversation information up to the present time from a configured time (e.g., 30 minutes or 1 hour) ago.

The electronic device may extract various categories of keyword text. For example, the categories may include events (e.g., travel, birthday, vacation, business trip, golf), persons (e.g., personal names), date/time (e.g., weekday, weekend), emotions (e.g., joy, anger, sorrow, delight), locations (e.g., LA, Hawaii), text related to images already used by the user, or object-related text (e.g., cakes, sunglasses).

The electronic device may extract the context of a conversation as a combination of category-specific text.

In operation 230, in response to a user input for generating an image displayable on the execution screen being received, the electronic device may identify an image corresponding to at least one keyword text among multiple images stored in the memory.

Images displayable on the execution screen of the message application may include sticker images, emoticons, emojis, still images, and moving images.

If a text window for inputting text on the execution screen is selected, the electronic device may display a soft keyboard for inputting text. A UI for generating images displayable on the execution screen may be included in an area of the soft keyboard. Upon receiving a user input for selecting the UI for generating images, the electronic device may identify an image corresponding to at least one keyword text among multiple images stored in the memory.

For example, the electronic device may display the UI for generating images in an activated state if images can be generated by extracted keyword text. If keyword text sufficient to generate images have not yet been extracted, the electronic device may display the UI for generating images in a deactivated state.

The electronic device may extract a related image among multiple images stored in the memory through at least one keyword text. For example, the electronic device may extract one of multiple images by comparing at least one keyword with information regarding persons, things, and animals included in images, place information, date information, and/or tag information stored with regard to each of multiple images.

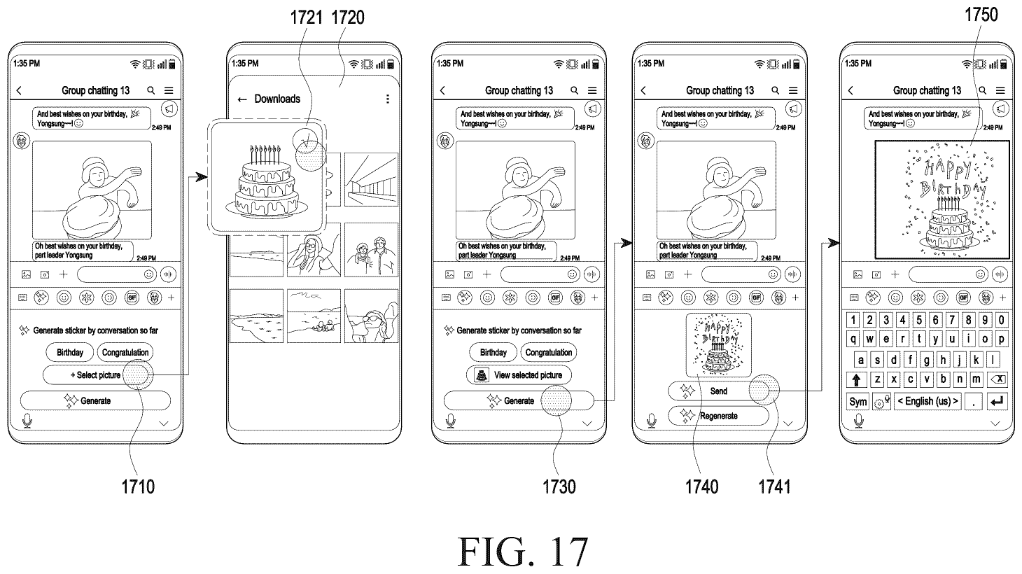

The electronic device may identify an image selected by a user input, among multiple images stored in the memory, as an image corresponding to at least one keyword text. For example, if the UI for generating images is selected, the electronic device may display a UI for selecting pictures. If the UI for selecting pictures is selected, the electronic device may display multiple images stored in the memory and may identify an image selected by a user input, among the multiple images, as an image corresponding to at least one keyword text (or an image to be used for image generation). The operation of selecting an image to be used for image generation by a user input will be described later in more detail with reference to FIG. 17.

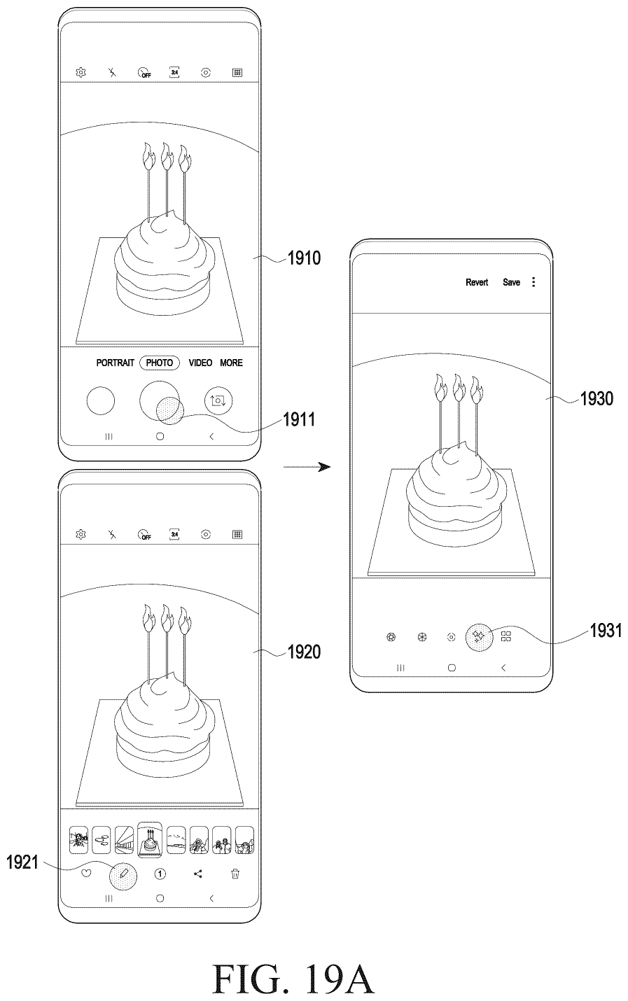

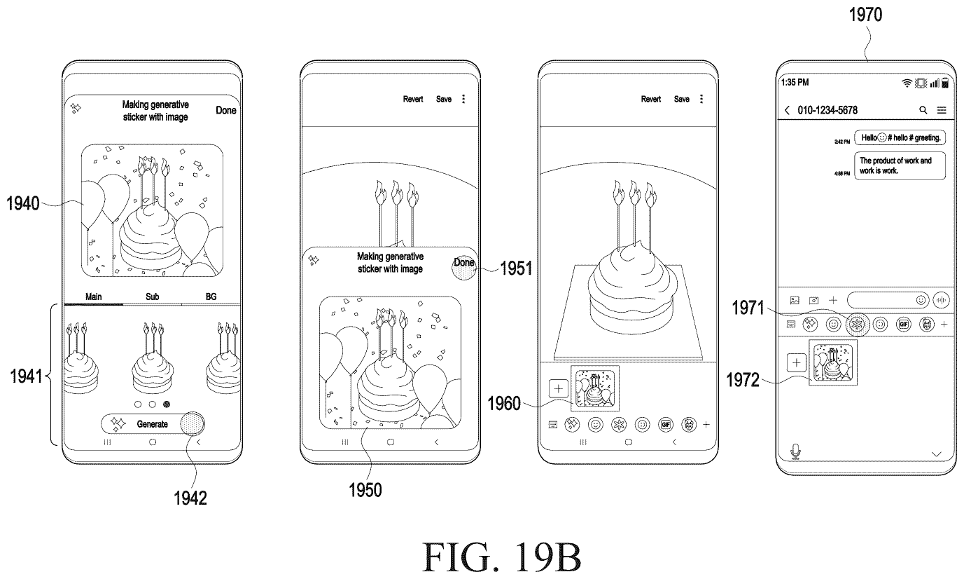

The electronic device may identify an image captured through a camera application as an image corresponding to at least one keyword text. For example, the electronic device may capture an image through the camera application and, upon receiving a user input such as selecting a UI for generating an image displayable on the message application by using the capture image, may identify the capture image as an image corresponding to at least one keyword text. According to an embodiment, the operation of generating images by using images captured through the camera application will be described later in more detail with reference to FIGS. 19A and 19B.

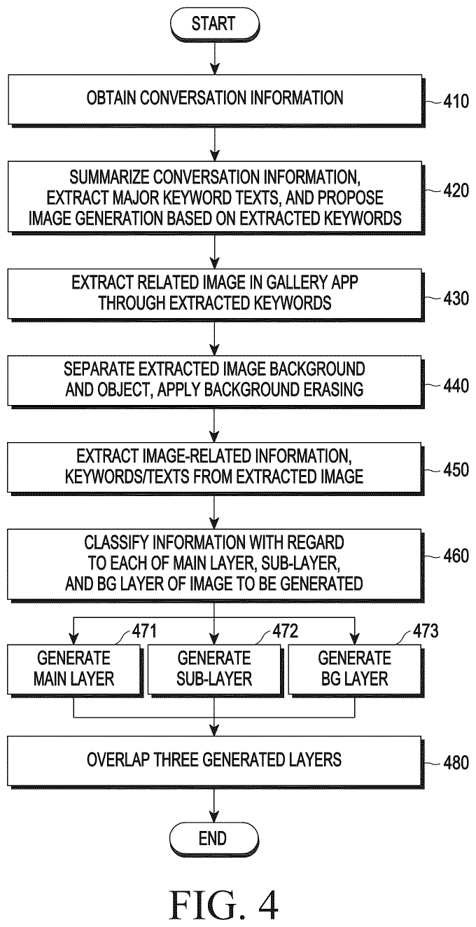

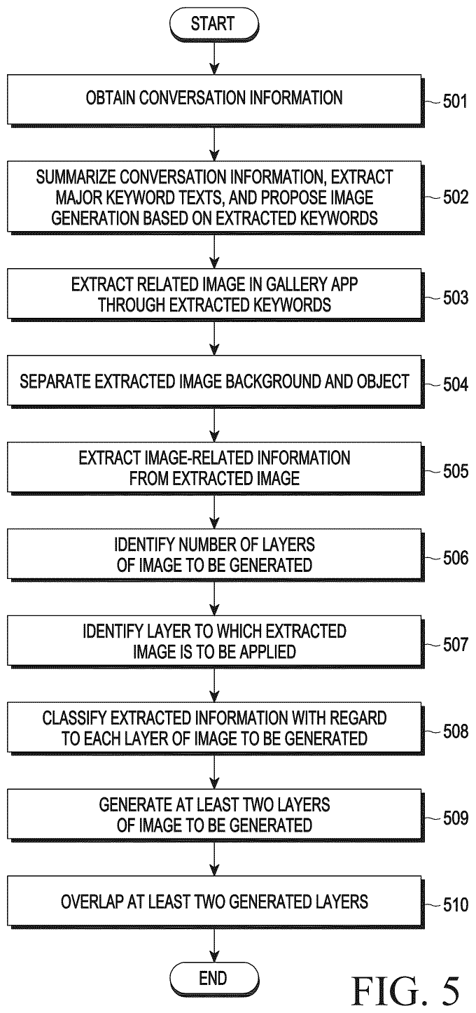

In operation 240, the electronic device may obtain at least one first layer, based on the identified image. The electronic device may generate a configured number of first layers or may determine the number of at least one first layer, based on at least one of conversation information, at least one keyword text, or information regarding the identified image, and may generate the determined number of first layers. The operation of generating a first layer, the configured number of which is one, will be described later in more detail with reference to FIG. 4. The operation of determining the number of at least one first layer and generating the determined number at least one first layer will be described later in more detail with reference to FIG. 5.

The electronic device may generate at least one first layer by using generative AI. For example, when generating a configured number of first layers, the electronic device may generate one first layer including an object included in an identified image. The first layer may be a main layer including a main object of an image to be generated.

When determining the number of at least one first layer and generating the determined number of at least one first layer, the electronic device may generate at least one first layer including a first layer including an object included in an identified image and/or a first layer including a background included in the identified image. The first layer including an object may be a main layer, and the first layer including a background may be a background layer.

The electronic device may determine whether or not to use at least one of an object included in an identified image or a background included in the identified image, based on at least one of conversation information, at least one keyword text, or information regarding the identified image. Information regarding the image may include image analysis information and/or meta information of the identified image. The image analysis information may include vision information (e.g., text, persons, costumes, weather, environments in the image) such as objects included in the image. The meta information may include information regarding the place (e.g., GPS information) at which the image is captured, date information, and/or tag information (e.g., text in the image or tags added by the user).

Based on determining to use the object of the identified image, the electronic device may generate a main layer including the object. Based on determining to use the background of the identified image, the electronic device may generate a background layer including the background.

The electronic device may generate a prompt to be input to generative AI, based on at least one of conversation information, at least one keyword text, or information regarding the identified image. The prompt may be generated by considering whether or not to include a motion effect (e.g., an animation effect) in the image (e.g., sticker image).

The electronic device may generate a prompt related to an effect to be applied to the main object included in the main layer, based on at least one of conversation information, at least one keyword text, or information regarding the identified image.

For example, the electronic device may generate a prompt (e.g., “‘smiling’ friends”) including the text ‘friends’ related to an object included in the identified image and the text ‘smiling’ related to an effect.

The electronic device may generate a prompt (e.g., “‘vibrating” palm tree”) including the text ‘palm tree” related to a background included in the identified image, and the text ‘vibrating’ related to an effect.

By using the generated prompt as input data to generative AI, the electronic device may obtain at least one first layer as output data from the generative AI.

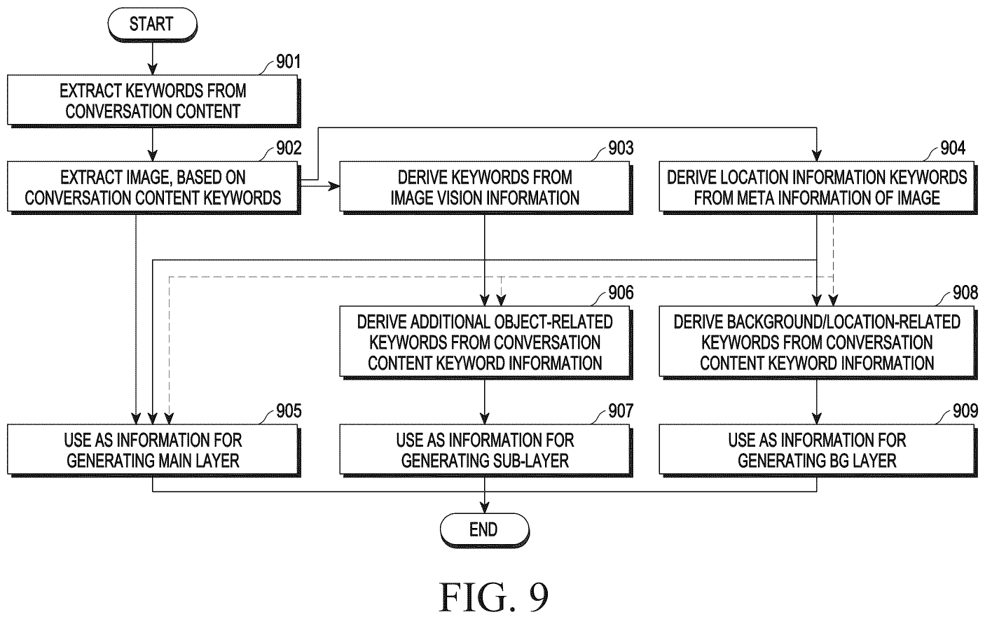

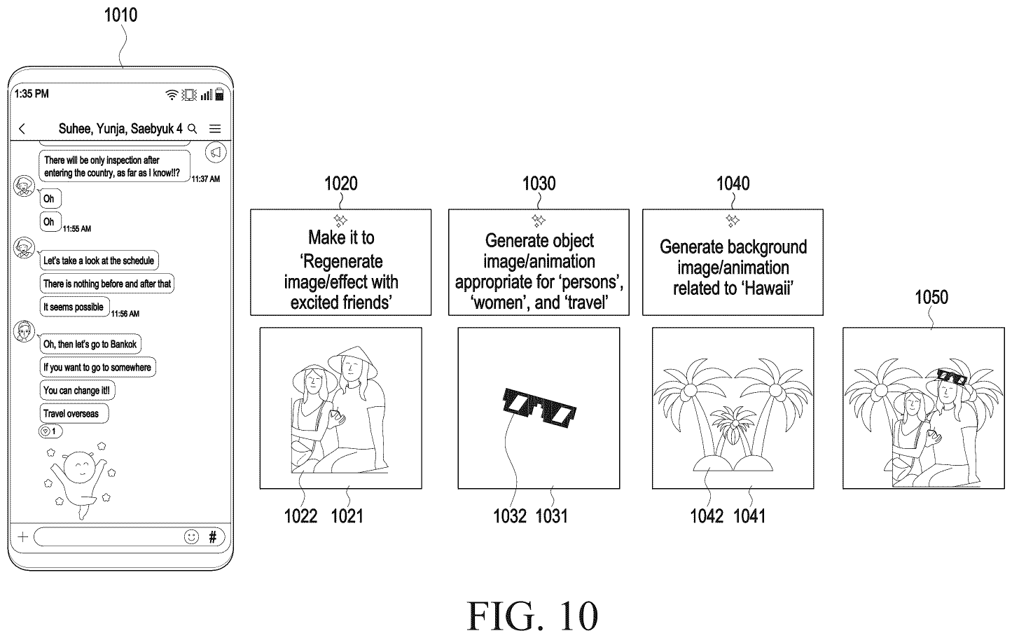

The operation of generating a layer, based on at least one of conversation information, at least one keyword text, or information regarding the identified image will be described later in more detail with reference to FIG. 9. The operation of generating a prompt which is input to generative AI to generate each layer will be described later in more detail with reference to FIGS. 10, 11, and 12.

In operation 250, the electronic device may obtain at least one second layer, based on at least one of conversation information, a keyword text, or information regarding an identified image.

The electronic device may generate a configured number of second layers or may determine the number of at least one second layer, based on at least one of conversation information, at least one keyword text, or information regarding the identified image, and may generate the determined number of second layers. The operation of generating a configured number (two) first layers will be described later in more detail with reference to FIG. 4. The operation of determining the number of at least one second layer and generating the determined number of at least one second layer will be described later in more detail with reference to FIG. 5.

The electronic device may generate at least one second layer by using generative AI. For example, when generating a configured number of second layers, the electronic device may generate two second layers, based on at least one of conversation information, at least one keyword text, or information regarding the identified image. The two second layers may include a sub-layer including a sub-object of an image to be generated, and a background layer including a background of the image to be generated. The sub-object may be related to an effect of an image to be generated in relation to conversation context based on at least one keyword and conversation information.

When determining the number of at least one second layer and generating the determined number of at least one second layer, the electronic device may generate one second layer including a sub-layer or a background layer, or may generate two or more sub-layers and/or two or more background layers.

Image-related information may include image analysis information and/or meta information of the identified image. The image analysis information may include vision information (e.g., text, persons, costumes, weather, environments in the image) such as objects included in the image. The meta information may include information regarding the place (e.g., GPS information) at which the image is captured, date information, and/or tag information (e.g., text in the image or tags added by the user).

The electronic device may determine that the number of second layers is one if the electronic device cannot obtain at least one of image analysis information of the identified image or meta information of the identified image. The electronic device may determine that the number of second layers is two or larger if there are two or more pieces of image analysis information of the identified image and two or more pieces of meta information.

The electronic device may generate a prompt to be input to generative AI, based on at least one of conversation information, at least one keyword text, or information regarding the identified image. The prompt may be generated by considering whether or not to include a motion effect (e.g., an animation effect) in the image (e.g., sticker image).

The electronic device may generate a prompt related to an effect to be applied to a sub-object included in a sub-layer and a prompt related to an effect to be applied to a background included in a background layer, based on at least one of conversation information, at least one keyword text, or information regarding the identified image.

For example, the electronic device may generate a prompt (e.g., “‘flying’ airplane”) including the text ‘airplane’ related to a sub-object and the text ‘flying’ related to an effect.

The electronic device may generate a prompt (e.g., “‘vibrating” palm tree”) including the text ‘palm tree” related to a background and the text ‘vibrating’ related to an effect.

By using the generated prompt as input data to generative AI, the electronic device may obtain at least one second layer as output data from the generative AI.

The operation of generating a layer, based on at least one of conversation information, at least one keyword text, or information regarding the identified image will be described later in more detail with reference to FIG. 9. The operation of generating a prompt which is input to generative AI to generate each layer will be described later in more detail with reference to FIGS. 10, 11, and 12.

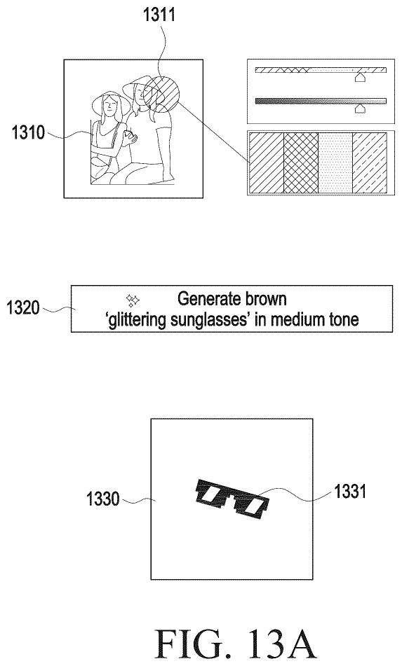

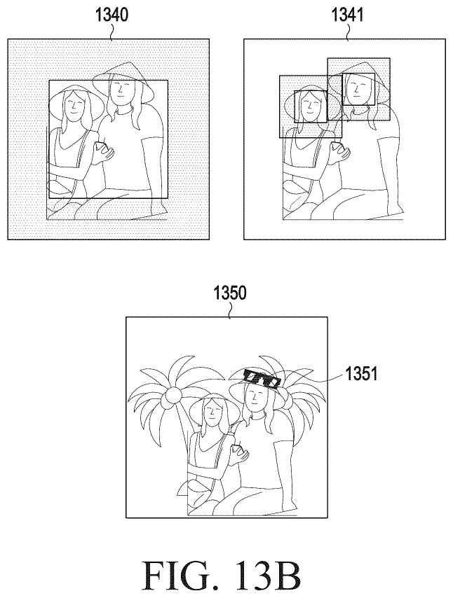

The electronic device may determine the color of the object included in at least one second layer, based on color information of an image identified based on at least one extracted keyword. The electronic device may determine the position of a sub-object, based on the position of a main object included in an image identified based on at least one extracted keyword. The operation of identifying the color of a second layer and the position of a sub-object, based on an image identified based on at least one keyword, will be described later in more detail with reference to FIGS. 13A and 13B.

In operation 260, the electronic device may generate an image by overlapping at least one first layer and at least one second layer.

The electronic device may generate an image by overlapping a main layer on a background layer and overlapping a sub-layer on the main layer.

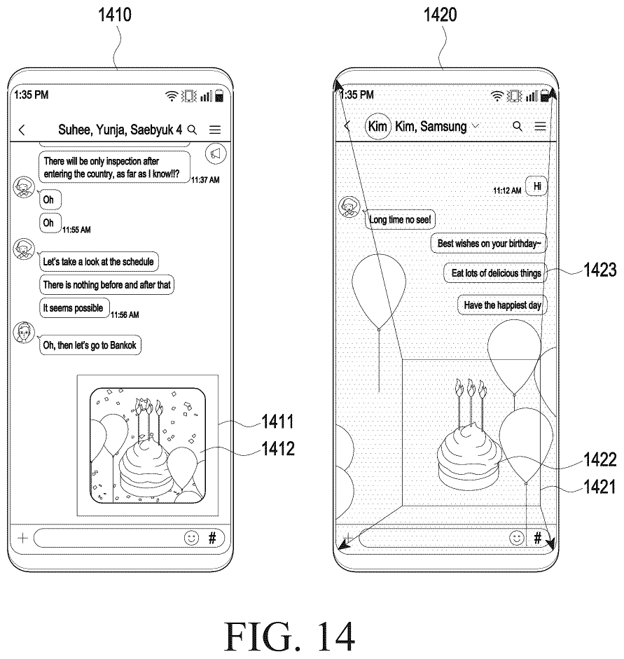

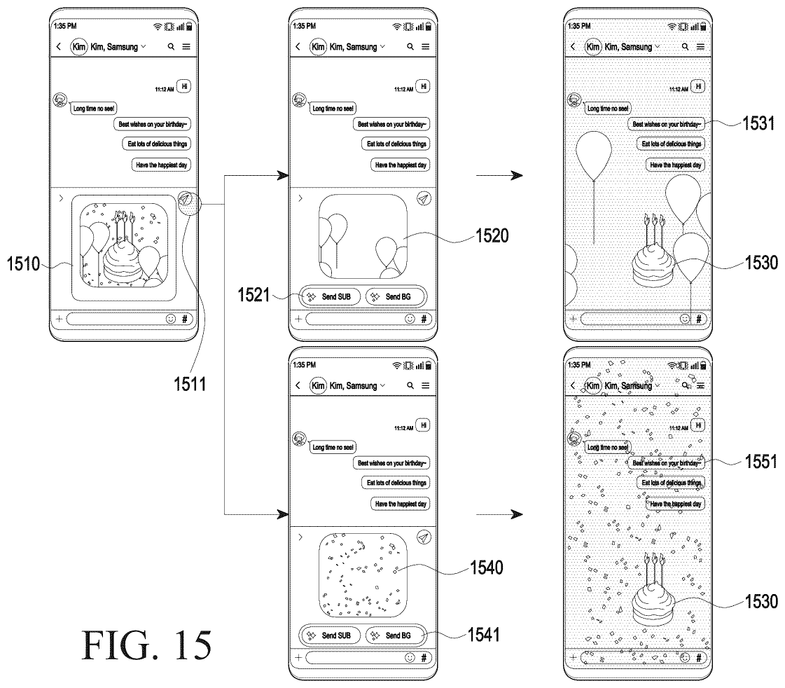

The electronic device may display a layer used as a background layer of a generated image, among at least one first layer and at least one second layer, in the entire area of the execution screen, based on a user input for displaying the generated image. The electronic device may display not only the background layer of the generated image, but also an object of a sub-layer, in the entire area of the execution screen. The operation of displaying some layers of the generated image on the full screen will be described later in more detail with reference to FIGS. 14 and 15.

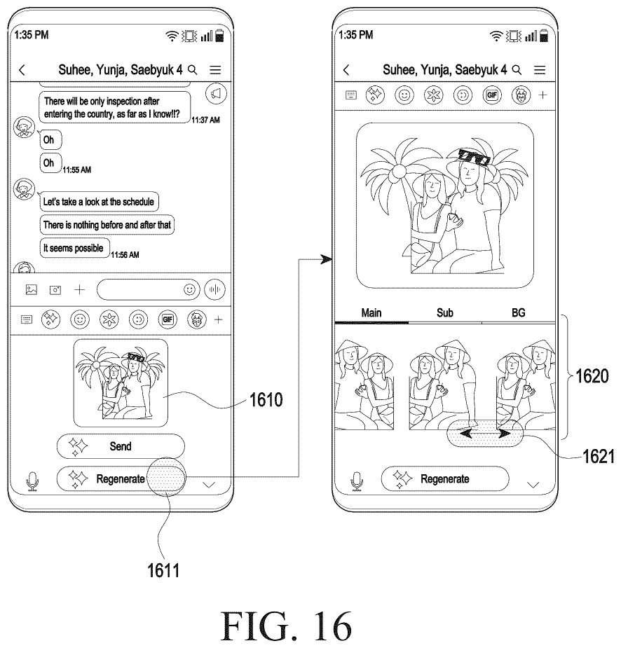

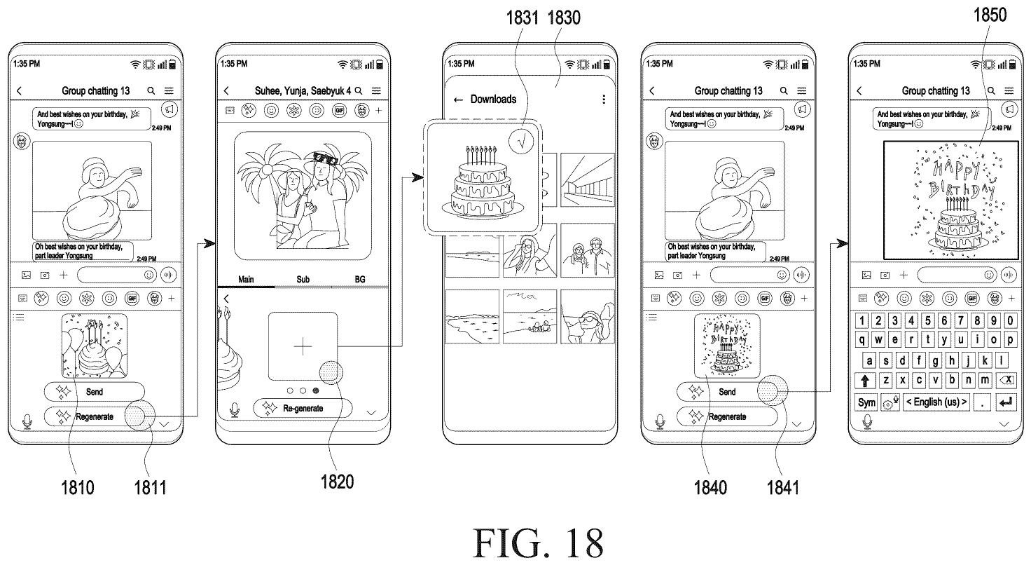

The electronic device may display the generated image as a preview in a soft keyboard area. The electronic device may modify the generated image, based on a use input for modifying the generated image. For example, the electronic device may change the main object, based on a user input, or may change the effect applied to each layer. The operation of modifying the generated image, based on a use input, will be described later in more detail with reference to FIGS. 16 and 18.

As such, images may be generated based on the content of a conversation through a message application such that personal emotions and linguistic intimacy can be expressed richly, and personalized images appropriate for the context of the conversation may be provided by generating images based on user information.

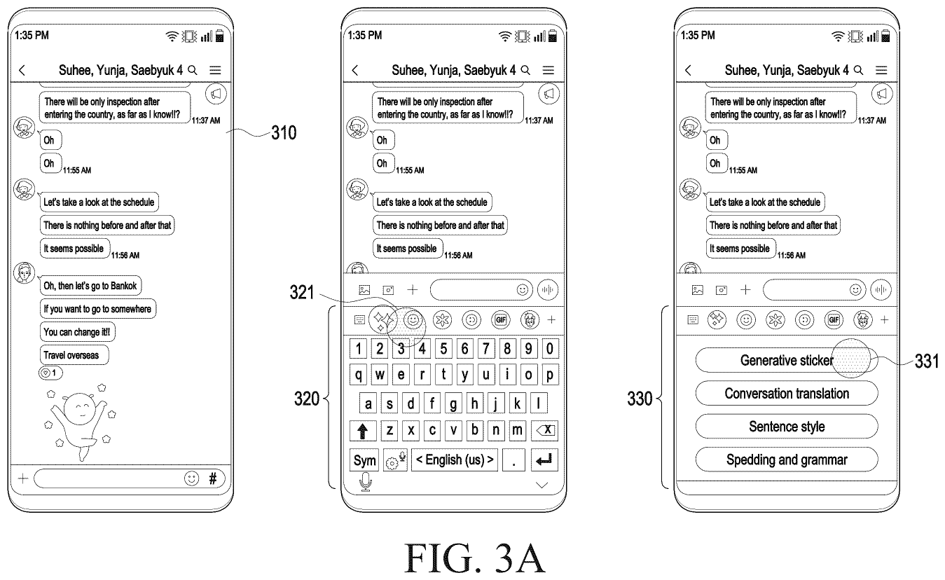

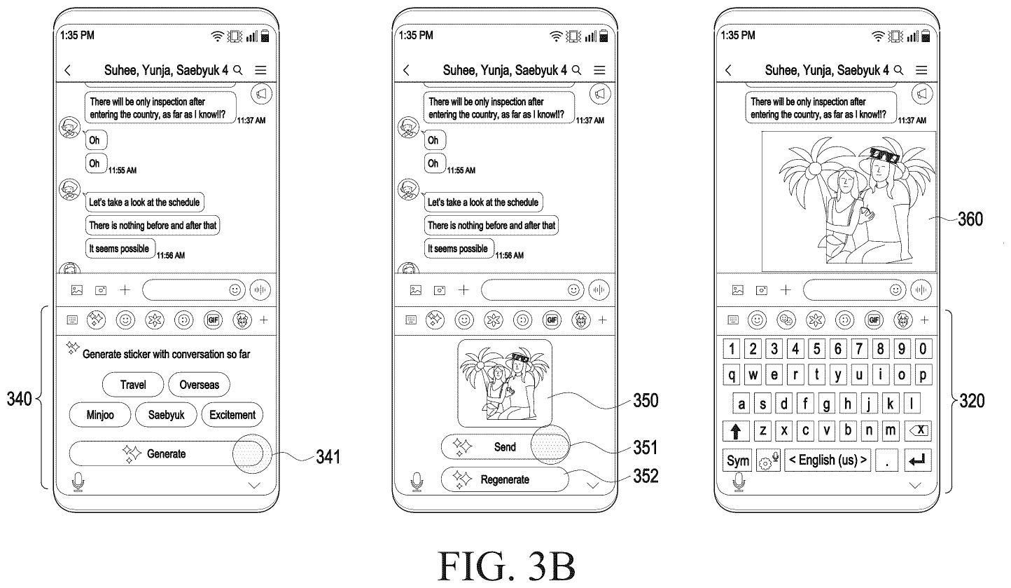

FIG. 3A illustrates an operation in which an electronic device generates an image, based on conversation information according to an embodiment of the disclosure.

Referring to FIG. 3A, the electronic device (e.g., the electronic device 101 in FIG. 1 or the processor 120 in FIG. 1) may display an execution screen 310 of a message application. For example, based on the content of a conversation which is currently displayed or has a history of being displayed on the execution screen 310 of a message application, the electronic device may summarize the content of the conversation and may extract at least one keyword text. For example, when a travel-related conversation has been made with friends (conversation counterparts) through the execution screen 310 of a message application, the electronic device may summarize the content of the conversation, based on information mentioned in the content of the conversation, and may extract major keywords related to travel.

If image generation is possible based on the summarized conversation content and major keywords, the electronic device may display a UI for executing an AI function in an activated state inside a soft keyboard area 320. For example, upon receiving a user input for selecting a text window for inputting text, the electronic device may display a soft keyboard area 320. For example, the soft keyboard area 320 may include multiple keys for inputting text and Uls for executing functions. For example, the electronic device may display the UI for executing an AI function in an activated state in which the same blinks.

Upon receiving a user input 321 for selecting the UI for executing an AI function, the electronic device may display an AI function-related list 330. For example, the electronic device may display the AI function-related list 330 instead of multiple keys for inputting text. For example, the AI function-related list 330 may include ‘generative sticker’ for generating images by using AI, ‘conversation translation’ for conducting translation by using AI, ‘sentence style’ for modifying sentences by using AI, and/or ‘spelling and grammar’ for correcting spelling errors by using AI.

Upon receiving a user unit 331 for selecting ‘generative sticker’ in the AI function-related list 330, the electronic device may perform the image generating operation illustrated in FIG. 3B.

Although it has been assumed in the description with reference to FIG. 3A that the function for generating images is selected after the UI for executing the AI function is selected, this assumption is not limitative, and a UI for generating images may be displayed in the soft keyboard area 320.

FIG. 3B illustrates an operation in which an electronic device generates an image, based on conversation information according to an embodiment of the disclosure.

Referring to FIG. 3B, the electronic device may display a screen 340 for image generation based on extracted keyword text instead of an AI function-related list (e.g., the AI function-related list 330 in FIG. 3A). The screen 340 for image generation may provide a UI for providing at least one extracted keyword text and generating images based on the at least one provided keyword text.

Upon receiving a user input 341 for selecting the UI for generating images, the electronic device may provide a preview 350 of a generated image. The electronic device may extract a related image among multiple images stored in the memory (e.g., multiple images stored in the album application), based on an extracted keyword text, and may extract a derived information keyword text from the extracted image. For example, the derived information keyword text may include image analysis information obtained by analyzing the image and meta information regarding the image. For example, the image analysis information may include personal information (e.g., personal name) included in the image, and the meta information may include place information.

Upon receiving a user input 351 for selecting a UI for transmitting the preview 350 of the generated image, the electronic device may display the generated image 360 in a partial area of the execution screen (e.g., conversation window) of the message application. The partial area may be an area designated such that images can be displayed inside the execution screen.

The electronic device may display a UI 352 (e.g., regenerate) for modifying the generated image together with the preview 350 of the generated image. The image modification operation when the UI 352 for modifying the generated image is selected will be described later in more detail with reference to FIGS. 16 and 18.

FIG. 4 is a flowchart illustrating operations in which an electronic device generates a configured number of layers, based on conversation information, thereby generating an image according to an embodiment of the disclosure. For example, FIG. 4 illustrates an operation of generating an image by using three layers, and the three layers may include a main layer, a sub-layer, and a background layer.

Referring to FIG. 4, in operation 410, the electronic device (e.g., the electronic device 101 in FIG. 1) may obtain conversation information. For example, the electronic device may obtain conversation information which is currently displayed or has a history of being displayed on the execution screen of the message application. The electronic device may obtain conversation information from the memory (e.g., the memory 130 in FIG. 1) or may obtain conversation information from the server related to the message application.

In operation 420, the electronic device may summarize the conversation information and extract major keyword text, based on the obtained conversation information, and may propose image generation. The image generation proposal may include proposing image generation based on the extracted keyword text, and may include an operation of activating and displaying a UI for image generation. The operation of summarizing conversation information and extracting major keyword text is identical to operation 220 in FIG. 2, and repeated descriptions thereof will be omitted herein.

In operation 430, the electronic device may extract an image through an extracted keyword text. The electronic device may extract an image related to the extracted keyword text among multiple images stored in the memory. The image extracting operation is identical to operation 230 in FIG. 2, and repeated descriptions thereof will be omitted herein.

In operation 440, the electronic device may separate the object and the background of the extracted image, and may apply background erasing. In order to obtain only the object included in the extracted image, the electronic device may separate the object and the background of the image and obtain the object only, or may delete the separated background.

In operation 450, the electronic device may extract image-related information from the extracted image. The image-related information may include image analysis information and/or meta information of the identified image. The image analysis information may include vision information (e.g., text, persons, costumes, weather, environments in the image) such as objects included in the image. The meta information may include information regarding the place (e.g., GPS information) at which the image is captured, date information, and/or tag information (e.g., text in the image or tags added by the user).

In operation 460, the electronic device may classify the extracted information with regard to each of the main layer, sub-layer, and BG layer of the image to be generated. For example, the electronic device may classify pieces of information to be used with regard to each layer among conversation information, keywords, and image-related information. The operation of classifying pieces of information to be used with regard to each layer will be described later in more detail with reference to FIG. 9.

In operation 471, the electronic device may generate the main layer. In operation 472, the electronic device may generate the sub-layer. In operation 473, the electronic device may generate the BG layer. The electronic device may generate the main layer, the sub-layer, and the BG layer by using generative AI. The operation of generating respective layers is identical to operation 240 and/or operation 250 in FIG. 2, and repeated descriptions thereof will be omitted herein.

In operation 480, the electronic device may overlap the three generated layers. The electronic device may generate an image by overlapping the three layers. According to an embodiment, the operation of generating an image by overlapping the generated layers is identical to operation 260 in FIG. 2, and repeated descriptions thereof will be omitted herein.

FIG. 5 is a flowchart illustrating operations in which an electronic device according to an embodiment of the disclosure. determines the number of layers, based on conversation information, and generates the determined number of layers, thereby generating an image. For example, FIG. 5 illustrates image generating operations further including an operation of determining, based on pieces of extracted information, the number of layers and the layer to which an extracted image is to be applied.

Referring to FIG. 5, in operation 501, the electronic device (e.g., the electronic device 101 in FIG. 1) may obtain conversation information. For example, the electronic device may obtain conversation information which is currently displayed or has a history of being displayed on the execution screen of the message application. The electronic device may obtain conversation information from the memory (e.g., the memory 130 in FIG. 1) or may obtain conversation information from the server related to the message application.

In operation 502, the electronic device may summarize the conversation information and extract major keyword text, based on the obtained conversation information, and may propose image generation. The image generation proposal is proposing image generation based on the extracted keyword text, and may include an operation of activating and displaying a UI for image generation. The operation of summarizing conversation information and extracting major keyword text is identical to operation 220 in FIG. 2, and repeated descriptions thereof will be omitted herein.

In operation 503, the electronic device may extract an image through an extracted keyword text. The electronic device may extract an image related to the extracted keyword text among multiple images stored in the memory. The image extracting operation is identical to operation 230 in FIG. 2, and repeated descriptions thereof will be omitted herein.

In operation 504, the electronic device may separate the object and the background of the extracted image. According to an embodiment, in order to generate a main layer based on the object, and/or to generate a background layer based on the background, the electronic device may separate the object and the background included in the extracted image.

In operation 505, the electronic device may extract image-related information from the extracted image. The image-related information may include image analysis information and/or meta information of the identified image. The image analysis information may include vision information (e.g., text, persons, costumes, weather, environments in the image) such as objects included in the image. The meta information may include information regarding the place (e.g., GPS information) at which the image is captured, date information, and/or tag information (e.g., text in the image or tags added by the user).

In operation 506, the electronic device may identify the number of layers of the image to be generated. The electronic device may identify the number of images to be generated, based on whether conversation content, an extracted keyword text, or image-related information is obtained or not. For example, the electronic device may identify that one or two layers are generated, based on an extracted image, based on whether a main layer and/or a background layer are generated or not, based on the extracted image. The electronic device may identify that one or more layers are generated, based on the number of pieces of obtained information among image analysis information and the image's meta information which are included in the image-related information. For example, if only one of the image analysis information and the image's meta information is obtained, the electronic device may identify that, among the sub-layer and the background layer, only one layer is generated.

The electronic device may identify that the number of layers is two or more.

In operation 507, the electronic device may identify the layer to which the extracted image is to be applied. The electronic device may determine whether or not to use the extracted image's object and/or background, based on conversation content, an extracted keyword text, or image-related information. Upon determining that the extracted image's object will be used, the electronic device may identify that the extracted image will be applied to the main layer. Upon determining that the extracted image's background will be used, the electronic device may identify that the extracted image will be applied to the background layer. Upon determining that the extracted image's background and object will be used, the electronic device may identify that the extracted image will be applied to the main layer and the background layer.

In operation 508, the electronic device may classify the extracted information with regard to each of at least two layers of the image to be generated. For example, the electronic device may classify the extracted information with regard to each of at least two layers among the main layer, the sub-layer, and the BG layer. For example, the electronic device may classify pieces of information to be used with regard to respective layers among conversation information, keywords, and image-related information. According to an embodiment, the operation of classifying pieces of information to be used with regard to respective layers will be described later in more detail with reference to FIG. 9.

In operation 509, the electronic device may generate at least two layers of the image to be generated. The electronic device may generate at least two layers among the main layer, the sub-layer, or the BG layer by using generative AI. The operation of generating respective layers is identical to operation 240 and/or operation 250 in FIG. 2, and repeated descriptions thereof will be omitted herein.

In operation 510, the electronic device may overlap at least two generated layers. The electronic device may generate an image by overlapping the at least two layers. The operation of generating an image by overlapping generated layers is identical to operation 260 in FIG. 2, and repeated descriptions thereof will be omitted herein.

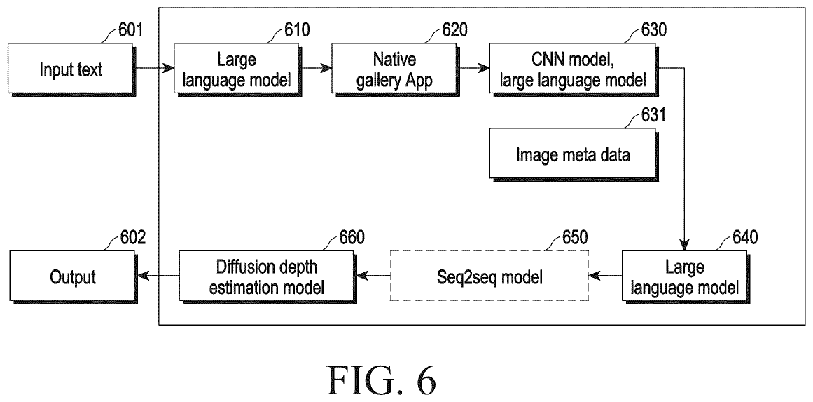

FIG. 6 illustrates an operation in which an electronic device generates an image, based on generative AI according to an embodiment of the disclosure.

Referring to FIG. 6, the electronic device (e.g., the electronic device 101 in FIG. 1) may input an input text 601 to a large language model (LLM) 610. For example, the input text 601 may include conversation content. The electronic device may summarize the conversation content through the LLM 610, and may extract major keyword text.

The electronic device may extract a related image among multiple images stored in a native gallery app 620 by using the extracted keyword text. The native gallery app 620 may have already been stored in the memory (e.g., the memory 130 in FIG. 1) of the electronic device when the electronic device was shipped. The electronic device may separate the extracted image's object and background.

The electronic device may obtain image-related information regarding the extracted image by using a CNN model and LLM 630. For example, the electronic device may obtain image analysis information (e.g., text, persons, costumes, weather, environments in the image) related to the object included in the image through the CNN model. The electronic device may input the image analysis information to the LLM, thereby obtaining a keyword text related to the image.

The electronic device may obtain meta information 631 of the extracted image. For example, the meta information 631 may include information regarding the place at which the image is captured, date information, and/or related tag information.

The electronic device may input the image analysis information-based keyword text and meta information 631 to an LLM 640, thereby generating a word, a phrase, and/or a sentence for image generation based on the extracted image and image related information. For example, the electronic device may generate a word, a phrase, and/or a sentence related to the person, atmosphere, object, place, date, or weather to be used for image generation.

The electronic device may input the generated word, phrase, and/or sentence to a sequence-to-sequence (seq2seq) model 650, thereby generating a prompt including a description text for effect (e.g., animation) generation as output data. For example, if the objects are friends, the electronic device may generate a prompt such as “‘smiling’ friends” including a description text such as ‘smiling’. If the object is an airplane, the electronic device may generate a prompt such as “‘flying’ airplane” including a description text such as ‘flying’. If the object is a palm tree, the electronic device may generate a prompt such as “‘quivering’ palm tree” including a description text such as ‘quivering’. The electronic device may generate a prompt corresponding to each of the main layer, the sub-layer, and/or the background layer.

The electronic device may generate each layer including an effect through an image generating model (e.g., diffusion depth estimation model) 660. In order to match the color tone of each layer, the electronic device may first generate the main layer and then generate the sub-layer and the background layer according to the color of the main layer.

The electronic device may output 602 the image generated by overlapping respective generated layers. According to an embodiment, the electronic device may encode the generated image and transmit the same through the message application.

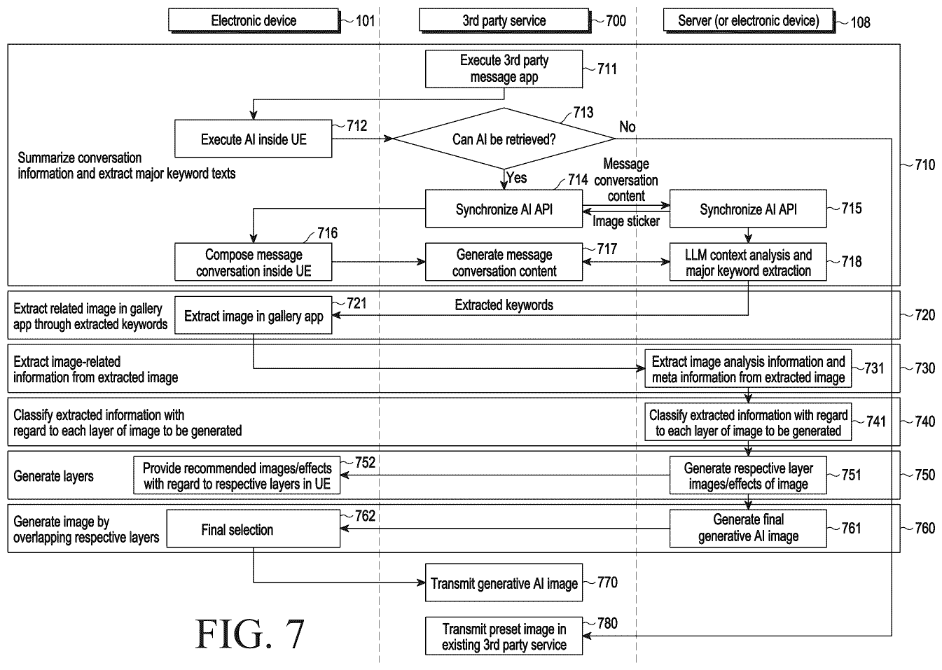

FIG. 7 is a flowchart illustrating a system for generating an image, based on conversation information, according to an embodiment of the disclosure. For example, FIG. 7 illustrates operations of generating an image through a 3^{rd} party service 700 which is an application installed by a user input.

Referring to FIG. 7, operations of generating an image, based on conversation information, may include an operation 710 of summarizing conversation information and extracting major keyword text, an operation 720 of extracting a related image in a gallery app through extracted keywords, an operation 730 of extracting image-related information from the extracted image, an operation 740 of classifying the extracted information with regard to each layer of an image to be generated, an operation 750 of generating layers, and an operation 760 of generating an image by overlapping respective layers.

The operation 710 of summarizing conversation information and extracting major keyword text may include an operation 711 in which a 3^{rd} party service 700 executes a 3^{rd} party message application. In operation 712, the electronic device (e.g., the electronic device 101 in FIG. 1 or the processor 120 in FIG. 1) may execute AI inside the UE upon identifying execution of the 3^{rd} party message application.

In operation 713, the 3^{rd} party service 700 may identify whether the AI executed in the electronic device 101 can be retrieved or not. The 3^{rd} party service 700 may proceed to operation 780 if the AI executed in the electronic device 101 cannot be retrieved (No in operation 713), and may transmit a preconfigured image which has previously been provided in the 3^{rd} party service 700. T the 3^{rd} party service 700 may synchronize the AI API with the server 108 (e.g., the server 108 in FIG. 1) or the electronic device 101 in operation 714 and operation 715 if the AI executed in the electronic device 101 can be retrieved (Y es in operation 713). If the operation of keyword extraction and image generation is performed in the server 108, the 3^{rd} party service 700 may synchronize with the server 108. If the operation of keyword extraction and image generation is performed on-device in the electronic device 101, the 3^{rd} party service 700 may synchronize with the electronic device 101. Although it will be assumed in the following description that the operation of keyword extraction and image generation is performed in the server 108, this assumption is not limitative, and the operation may also be performed in the electronic device 101.

For example, the 3^{rd} party service 700 may transmit message conversation content to the server 108, and the server 108 may transmit a generated image (e.g., a sticker image) to the 3^{rd} party service 700, thereby performing synchronization.

In operation 716, the electronic device 101 may compose a message conversation inside the UE. For example, the electronic device 101 may compose a message conversation, based on a user input through a soft keyboard.

In operation 717, the 3^{rd} party service 700 may generate message conversation content, based on the message conversation composed in the electronic device 101. For example, the 3^{rd} party service 700 may generate message conversation content by displaying the message conversation composed in the electronic device 101 on the execution screen.

In operation 718, the server 108 may perform LLM context analysis and major keyword extraction, based on the message conversation content received from the 3^{rd} party service 700.

The operation 720 of extracting a related image in a gallery app through extracted keywords may include an operation 721 in which the electronic device 101 extracts an image in a gallery application, based on keyword information received from the server 108. For example, the electronic device 101 may extract one of multiple images by comparing extracted keywords with information regarding persons, things, and animals included in images, place information, date information, and/or tag information stored with regard to each of multiple images in the gallery application.

The operation 730 of extracting image-related information from the extracted image may include an operation 731 in which the server 108 extracts image analysis information and meta information from the extracted image. The image-related information may include image analysis information and/or meta information of the identified image. The image analysis information may include vision information (e.g., text, persons, costumes, weather, environments in the image) such as objects included in the image. The meta information may include information regarding the place (e.g., GPS information) at which the image is captured, date information, and/or tag information (e.g., text in the image or tags added by the user).

The operation 740 of classifying the extracted information with regard to each layer of an image to be generated may include an operation 741 in which the server 108 classifies the extracted information with regard to each layer of an image to be generated. For example, the server 108 may classify pieces of information to be used with regard to each of the main layer, sub-layer, and BG layer of the image to be generated, among conversation information, keywords, and image-related information.

The operation 750 of generating layers may include an operation 751 in which the server 108 generates the image's respective layer images and effects. For example, the server 108 may generate images and effects of the main layer, sub-layer, and BG layer, respectively. The server 108 may generate respective layers' images and effects by using generative AI.

In operation 752, the electronic device 101 may receive respective layers' images and effects generated from the server 108 and may provide recommended images and effects with regard to respective layers. For example, the electronic device 101 may display images and effects generated with regard to respective layers such that the user can identify images and effects with regard to respective layers before image generation. Upon receiving a user input for changing images and/or effects with regard to respective layers, the electronic device 101 may transmit change information to the server 108 such that the server 108 changes images and/or effects with regard to respective layers.

The operation 760 of generating an image by overlapping respective layers may include an operation 761 in which the server 108 generates an image by overlapping respective layers. For example, the server 108 may generate an image by overlapping a background layer, a main layer, and a sub-layer from the bottom to the top.

The electronic device 101 may receive the generated image and display the same as a preview. In operation 762, the electronic device 101 may receive a user input of finally selecting the image displayed as a preview. For example, the electronic device 101 may receive a user input for displaying the image displayed as a preview on the execution screen of the 3^{rd} party service 700.

In operation 770, the 3^{rd} party service 700 may transmit the generated image. For example, the 3^{rd} party service 700 may display the generated image on the execution screen such that the generated image is transmitted to the conversation counterpart.

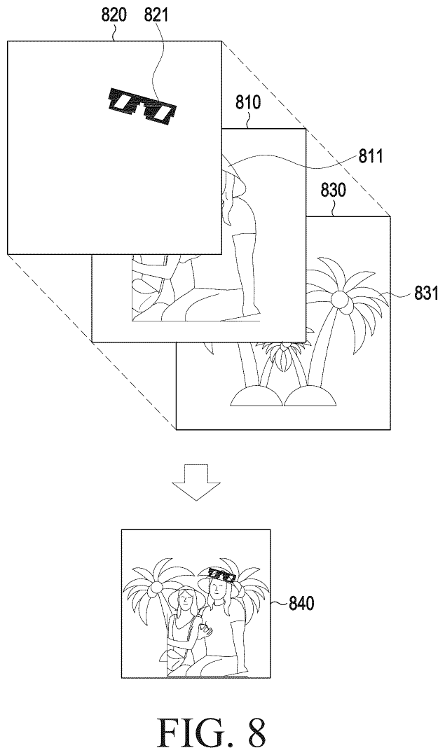

FIG. 8 illustrates an operation in which an electronic device generates an image by using multiple layers generated based on conversation information according to an embodiment of the disclosure.

Referring to FIG. 8, the electronic device (e.g., the electronic device 101 in FIG. 1) may generate an image 840 (e.g., a sticker image, an emoticon, an emoji, a still image, or a moving image) displayable on the execution screen of the message application by overlapping a main layer 810, a sub-layer 820, and a background layer 830.

The electronic device may use an image extracted based on a keyword text extracted form conversation content, vision information of the extracted image, and the extracted keyword text as input data to generative AI, thereby obtaining a main layer 810 as output data. The main layer 810 may be obtained by regenerating a part of the object of the extracted image. For example, based on extracted keywords ‘travel’ and ‘excitement’, the electronic device may generate a prompt such as ‘Make the input image look excited’, and may input the prompt to generative AI, thereby regenerating a part of the extracted image. For example, the main layer 810 may include a person object 811 regenerated so as to look excited.

The electronic device may use vision information of the image extracted based on keyword text extracted from conversation content, and the extracted keywords as input data to generative AI, thereby obtaining a sub-layer 820 as output data. The sub-layer 820 may be obtained by newly generating a sub-object 821. For example, based on the image's vision information ‘women’ and ‘persons’, the electronic device may generate a prompt such as ‘Make me glittering sunglasses’, and may input the prompt to generative AI, thereby generating a sub-object 821. For example, the sub-layer 820 may include an object 821 corresponding to glittering sunglasses.

The electronic device may use meta information (e.g., location, date, tag) of the image extracted based on keyword text extracted from conversation content, and the extracted keywords as input data to generative AI, thereby obtaining a background layer 830 as output data. The background layer 830 may be obtained by newly generating a background object 831. For example, based on location information (e.g., Hawaii) which is meta information of the image, the electronic device may generate a prompt such as ‘Make me a vibrating palm tree’, and may input the prompt to generative AI, thereby generating a background object 831. For example, the background layer 830 may include an object 831 corresponding toa vibrating palm tree.

The electronic device may generate the main layer 810, the sub-layer 820, and the background layer 830 in this order, and may generate the sub-layer 820 and the background layer 830, based on the style (e.g., color) of the main layer 810.

FIG. 9 is a flowchart illustrating operations in which an electronic device generates multiple layers, based on conversation information according to an embodiment of the disclosure.

Referring to FIG. 9, in operation 901, the electronic device (e.g., the electronic device 101 in FIG. 1 may extract keywords from conversation content. The operation of extracting keywords is identical to operation 220 in FIG. 2, and repeated descriptions thereof will be omitted herein.

In operation 902, the electronic device may extract an image, based on conversation content keywords, among multiple images stored in the memory (e.g., the memory 130 in FIG. 1). The operation of extracting an image is identical to operation 230 in FIG. 2, and repeated descriptions thereof will be omitted herein.

In operation 903, the electronic device may extract keywords from image vision information of the extracted image. For example, the electronic device may extract keywords related to text, persons, costumes, weather, and/or environments in the image.

In operation 904, the electronic device may extract keywords from meta information of the extracted image. For example, the electronic device may extract keywords related to information regarding the location at which the image is captured, date information, and/or tag information.

In operation 905, the electronic device may use the image extracted in operation 902, the keywords extracted in operation 903, and/or the keywords extracted in operation 904 as information for generating a main layer. When classifying information to be used for the main layer, the electronic device may assign priority in the order of conversation information, vision information, and meta information. For example, in order to generate an image conforming to conversation context, the electronic device may preferentially use information obtained by conversion content to generate the main layer. If there is no information to additionally use in the conversation information, the electronic device may use information extracted from the image vision information and information extracted from the image meta information to generate layers.

In operation 906, the electronic device may extract keywords related to a sub-object from conversation content keyword information. According to an embodiment, the electronic device may extract keywords through operation 903, may extract keywords through operation 904, and may additionally derive keywords related to a sub-object from conversation content keyword information.

In operation 907, the electronic device may use the image extracted in operation 903, the keywords extracted in operation 904, and/or the keywords extracted in operation 906 as information for generating a sub-layer. When classifying information to be used for the sub-layer, the electronic device may assign priority in the order of vision information, conversation information, and meta information. For example, in order to generate a sub-object having no discordance from the main layer, the electronic device may preferentially use vision information of the extracted image to generate the sub-layer.

In operation 908, the electronic device may derive background and/or location-related keywords from conversation content keyword information. The electronic device may extract keywords through operation 903, may extract keywords through operation 904, and may additionally derive background and/or location-related keywords from conversation content keyword information.

In operation 909, the electronic device may use the image extracted in operation 903, the keywords extracted in operation 904, and/or the keywords extracted in operation 908 as information for generating a background layer. When classifying information to be used for the background layer, the electronic device may assign priority in the order of meta information, conversation information, and vision information. For example, in order to generate a background object having no discordance from the main layer and to provide a colorful image, the electronic device may preferentially use meta information to generate the background layer.

FIG. 10 illustrates operations in which an electronic device generates multiple layers, based on conversation information according to an embodiment of the disclosure.

Referring to FIG. 10, the electronic device (e.g., the electronic device 101 in FIG. 1 or the processor 120 in FIG. 1) may extract keyword text, based on conversation information which is currently displayed or has a history of being displayed on the execution screen 1010 of the message application. Information obtainable based on keyword text may include events (e.g., travel, birthday, anniversary, vacation), date, time, emotions (e.g., joy, anger, sorrow, delight), and/or places.

The electronic device may obtain a related image among multiple stored images, based on the extracted keyword text. For example, the electronic device may obtain a related image, based on ‘travel’, ‘overseas’, ‘personal names (e.g., Minjoo, Saebyuk)’, and ‘exciting’, which are keyword text included in conversation content.

The electronic device may obtain image-related information from the extracted image. For example, the electronic device may obtain image vision information (e.g., persons, things, animals) from the image. The electronic device may obtain meta information (e.g., location information, date information, tag information) of the extracted image. For example, the location information may include the detailed location (e.g., Paris) at which the image is captured, and landmark information (e.g., Eiffel Tower). The date information may include the date (e.g., anniversary, appointed date) at which the image is captured. The tag information may include text in the image and/or tags added by the user.

The electronic device may generate a prompt 1020 for generating a main layer 1021, based on conversation content. For example, the prompt 1020 for generating a main layer 1021 may be ‘Regenerate the image/effect with excited friends’ including ‘travel’ and ‘excited’ which are keywords included in the conversation content. The electronic device may input the prompt 1020 for generating a main layer 1021 to generative AI, thereby obtaining the main layer 1021 as output data. The main layer 1021 may include an object 1022 corresponding to excited friends.

The electronic device may generate a prompt 1030 for generating a sub-layer 1031, based on conversation content, extracted keywords, and/or image vision information. For example, the prompt 1030 for generating a sub-layer 1031 may be ‘Generate an object image/animation appropriate for persons, women, and travel’ including ‘travel’ which is a keyword included in the conversation content and ‘persons’ and ‘women’ which are keywords included in the vision information. The electronic device may input the prompt 1030 for generating a sub-layer 1031 to generative AI, thereby obtaining the sub-layer 1031 as output data. The sub-layer 1031 may include an object 1032 corresponding to sunglasses.

The electronic device may generate a prompt 1040 for generating a background layer 1041, based on image meta information. For example, the prompt 1040 for generating a background layer 1041 may be ‘Generate a background image/animation related to Hawaii’ including ‘Hawaii’ which is a keyword related to location information included in the meta information. The electronic device may input the prompt 1040 for generating a background layer 1041 to generative AI, thereby obtaining the background layer 1041 as output data. The background layer 1041 may include an object 1042 corresponding to a vibrating palm tree.

The electronic device may generate the final image 1050 by overlapping the main layer 1021, the sub-layer 1031, and the background layer 1041. For example, the electronic device may generate the final image 1050 by overlapping the object 1022 corresponding to excited friends included in the main layer 1021, the object 1032 corresponding to sunglasses included in the sub-layer 1031, and the object 1042 corresponding to a vibrating palm tree included in the background layer 1041.

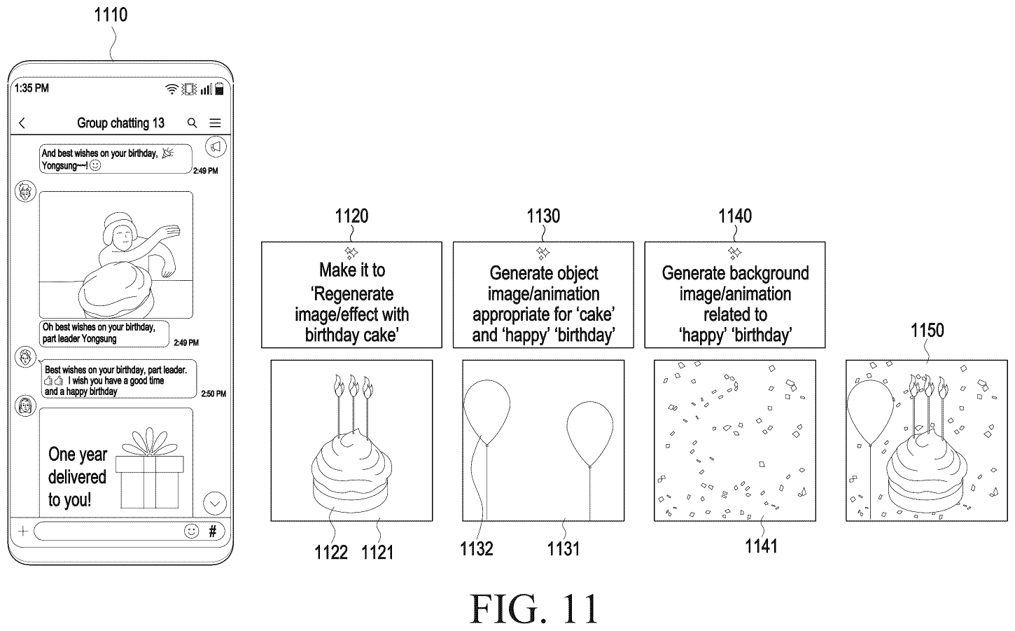

FIG. 11 illustrates operations in which an electronic device generates multiple layers, based on conversation information according to an embodiment of the disclosure.

Referring to FIG. 11, the electronic device (e.g., the electronic device 101 in FIG. 1 or the processor 120 in FIG. 1) may extract keyword text, based on conversation information which is currently displayed or has a history of being displayed on the execution screen 1110 of the message application. Information obtainable based on keyword text may include events (e.g., travel, birthday, anniversary, vacation), date, time, emotions (e.g., joy, anger, sorrow, delight), and/or places.

The electronic device may obtain a related image among multiple stored images, based on extracted keyword text. For example, the electronic device may obtain a related image (e.g., birthday cake image), based on ‘birthday’ and ‘happiness’ which are keyword text included in conversation content.

The electronic device may obtain image-related information from the extracted image. For example, the electronic device may obtain image vision information (e.g., persons, things, animals) from the image. The electronic device may obtain meta information (e.g., location information, date information, tag information) of the extracted image. For example, the location information may include the detailed location (e.g., Paris) at which the image is captured, and landmark information (e.g., Eiffel Tower). The date information may include the date (e.g., anniversary, appointed date) at which the image is captured. The tag information may include text in the image and/or tags added by the user.

The electronic device may generate a prompt 1120 for generating a main layer 1121, based on conversation content. For example, the prompt 1120 for generating a main layer 1121 may be ‘Regenerate the image/effect with a birthday cake’ including ‘birthday’ which is a keyword included in the conversation content. The electronic device may input the prompt 1120 for generating a main layer 1121 to generative AI, thereby obtaining the main layer 1121 as output data. The main layer 1121 may include an object 1122 corresponding to a birthday cake having glowing candles.

The electronic device may generate a prompt 1130 for generating a sub-layer 1131, based on conversation content, extracted keywords, and/or image vision information. For example, the prompt 1130 for generating a sub-layer 1131 may be ‘Generate an object image/animation appropriate for a cake and a happy birthday’ including ‘birthday’ and ‘happy’ which are keywords included in the conversation content and ‘cake’ which is a keyword included in the vision information. The electronic device may input the prompt 1130 for generating a sub-layer 1131 to generative AI, thereby obtaining the sub-layer 1131 as output data. The sub-layer 1131 may include an object 1132 corresponding to a floating balloon.

If there is no information for generating a sub-object in the conversation content, extracted keywords, and vision information, the electronic device may generate a sub-layer by generating a text wording (e.g., Congratulations on your twentieth birthday!) including an extracted keyword (e.g., birthday).

The electronic device may generate a prompt 1140 for generating a background layer 1141, based on image vision information and conversation content. For example, the prompt 1140 for generating a background layer 1141 may be ‘Generate a background image/animation related to a happy birthday’ including ‘cake’ and ‘balloon’ which are keywords included in the image vision information and ‘birthday’ and ‘happy’ which are keywords included in the conversation content. The electronic device may input the prompt 1140 for generating a background layer 1141 to generative AI, thereby obtaining the background layer 1141 as output data. The background layer 1141 may include an object 1142 corresponding to scattering pollen.

The electronic device may generate the final image 1150 by overlapping the main layer 1121, the sub-layer 1131, and the background layer 1141. For example, the electronic device may generate the final image 1150 by overlapping the object 1122 corresponding to a birthday cake having glowing candles included in the main layer 1121, the object 1132 corresponding to a floating balloon included in the sub-layer 1131, and the object 1142 corresponding to scattering pollen included in the background layer 1141.

According to an embodiment of the disclosure, a different image may be generated, if the image stored in the electronic device is different, although the conversation content is identical. For example, respective users included in the conversation group share the same conversation content, but different images are stored in devices of respective users, and different images may thus be generated.

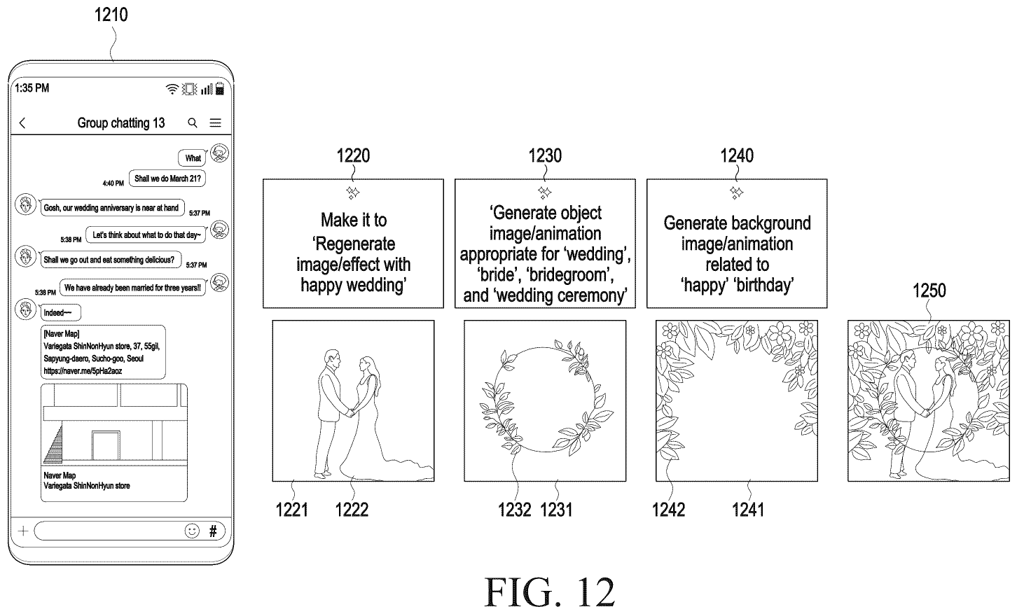

FIG. 12 illustrates operations in which an electronic device generates multiple layers, based on conversation information according to an embodiment of the disclosure.

Referring to FIG. 12, the electronic device (e.g., the electronic device 101 in FIG. 1 or the processor 120 in FIG. 1) may extract keyword text, based on conversation information which is currently displayed or has a history of being displayed on the execution screen 1210 of the message application. Information obtainable based on keyword text may include events (e.g., travel, birthday, anniversary, vacation), date, time, emotions (e.g., joy, anger, sorrow, delight), and/or places.

The electronic device may obtain a related image among multiple stored images, based on extracted keyword text. For example, the electronic device may obtain a related image, based on ‘wedding’, ‘anniversary’, ‘happy’, and ‘March 21^{st}>which are keyword text included in conversation content.

The electronic device may obtain image-related information from the extracted image. For example, the electronic device may obtain image vision information (e.g., persons, things, animals) from the image. The electronic device may obtain meta information (e.g., location information, date information, tag information) of the extracted image. For example, the location information may include the detailed location (e.g., Paris) at which the image is captured, and landmark information (e.g., Eiffel Tower). The date information may include the date (e.g., anniversary, appointed date) at which the image is captured. The tag information may include text in the image and/or tags added by the user.

The electronic device may generate a prompt 1220 for generating a main layer 1221, based on conversation content. For example, the prompt 1220 for generating a main layer 1221 may be ‘Regenerate the image/effect with a happy wedding’ including ‘wedding’ and ‘happy’ which are keywords included in the conversation content. The electronic device may input the prompt 1220 for generating a main layer 1221 to generative AI, thereby obtaining the main layer 1221 as output data. The main layer 1221 may include an object 1222 corresponding to a couple facing each other.

The electronic device may generate a prompt 1230 for generating a sub-layer 1231, based on conversation content, extracted keywords, and/or image vision information. For example, the prompt 1230 for generating a sub-layer 1231 may be ‘Generate an object image/animation appropriate for a wedding, a bride, a bridegroom, and a wedding ceremony’ including ‘wedding’, ‘wedding ceremony’, and ‘anniversary’ which are keywords included in the conversation content and ‘couple’, ‘love’, ‘bride’, and ‘bridegroom’ which are keywords included in the vision information. The electronic device may input the prompt 1230 for generating a sub-layer 1231 to generative AI, thereby obtaining the sub-layer 1231 as output data. The sub-layer 1231 may include an object 1232 corresponding to a flower wreath.

The electronic device may generate a prompt 1240 for generating a background layer 1241, based on image vision information and image meta information. For example, the prompt 1240 for generating a background layer 1241 may be ‘Generate a background image/animation related to a wedding hall’ including ‘couple’, ‘love’, ‘bride’, and ‘bridegroom’, which are keywords included in the image vision information and ‘wedding hall’ which is a keyword related to location information included in the meta information. The electronic device may input the prompt 1240 for generating a background layer 1241 to generative AI, thereby obtaining the background layer 1241 as output data. The background layer 1241 may include an object 1242 corresponding to a flowery creeper.

The electronic device may generate the final image 1250 by overlapping the main layer 1221, the sub-layer 1231, and the background layer 1241. For example, the electronic device may generate the final image 1250 by overlapping the object 1222 corresponding to a couple facing each other included in the main layer 1221, the object 1232 corresponding to a flower wreath included in the sub-layer 1231, and the object 1242 corresponding to a flowery creeper included in the background layer 1241.

FIG. 13A illustrates an operation in which an electronic device generates a sub-layer, based on color information of an image extracted based on conversation information according to an embodiment of the disclosure.

Referring to FIG. 13A, the electronic device (e.g., the electronic device 101 in FIG. 1 or the processor 120 in FIG. 1) may identify major color information 1311 of an object 1310 included in the main layer. For example, the color information 1311 may include color and brightness. The object 1310 included in the main layer may be an object included in an image extracted based on a keyword extracted from conversation content.

The electronic device may extract major color information 1311 of the object 1310 included in the main layer, and may generate a prompt 1320 for generating a sub-layer 1330 with a color and a brightness in a similar color group and a similar brightness group. For example, the prompt 1320 for generating a sub-layer 1330 may be ‘Generate brown glittering sunglasses in a medium tone’.

The electronic device may input the prompt 1320 for generating a sub-layer 1330 to generative AI, thereby obtaining the sub-layer 1330 as output data. According to an embodiment, the sub-layer 1330 may include an object 1331 corresponding to brown glittering sunglasses.

FIG. 13B illustrates an operation in which an electronic device arranges an object of a sub-layer, based on an object of an image extracted based on conversation information according to an embodiment of the disclosure.

Referring to FIG. 13B, the electronic device may arrange a sub-object in an area 1340 of the main layer, which is not deformed by generative AI. For example, the main object of the main layer has been regenerated through generative AI so as to look excited, the electronic device may arrange a sub-object in a peripheral area of the main object, which is not deformed.

If the sub-object is related to a person, the electronic device may arrange the sub-object in the peripheral area 1341 of the main object (person). For example, if the sub-object is sunglasses to be mounted on the person's face, the electronic device may arrange the same in the peripheral area 1341 of the face of the person object.

As such, the electronic device may generate the final image 1350 in which the sub-object 1351 (sunglasses) is arranged on the person's eyes or head.

FIG. 14 illustrates an operation in which an electronic device displays a generated image on the full screen according to an embodiment of the disclosure.

Referring to FIG. 14, if an image has been generated through a message application which is a 3^{rd} party service downloaded and installed by a user input, the electronic device (e.g., the electronic device 101 in FIG. 1 or the processor 120 in FIG. 1) may display the generated image 1412 in a designated area 1411 inside the execution screen 1410 of the 3^{rd} party service.

If an image has been generated through a message application which is a native service already stored when the electronic device was shipped, the main layer 1422 of the generated image may be displayed in a designated area, and some layers 1421 (e.g., sub-layer or background layer) may be displayed through the entire area 1423 in the execution screen 1420 of the native service. For example, upon receiving a user input for displaying the generated image or a user input for selecting a displayed image while a generated image is displayed in a designated area, the electronic device may maintain the cake object included in the main layer 1422 in the designated area, and may display floating balloon objects of the sub-layer 1421 through the entire area 1423 in the execution screen 1420 of the native service.

FIG. 15 illustrates an operation in which an electronic device displays a generated image on the full screen according to an embodiment of the disclosure.

Referring to FIG. 15, the electronic device (e.g., the electronic device 101 in FIG. 1 or the processor 120 in FIG. 1) may display a preview image 1510 of the generated image, instead of a soft keyboard, in the soft keyboard area. Upon receiving a user input 1511 for displaying the generated image, the electronic device may display a screen for selecting which layer, among the sub-layer and background layer of the generated image, will be displayed on the full screen. The electronic device may obtain attribute information for displaying the sub-layer or background layer on the full screen. For example, the attribute information may include the full screen's ratio (e.g., 16:9) of, the layer's position (e.g., front or rear), and the display time (e.g., for three seconds).

The electronic device may display a preview image 1520 of the sub-layer. If a UI 1521 for displaying the sub-layer on the full screen is selected, the electronic device may display a main layer 1530 including a birthday cake object in a designated area of the execution screen of the message application, and may display a sub-layer 1531 including a floating balloon object in the entire area of the execution screen of the message application.

The electronic device may display the sub-layer 1531 on the full screen by using a prompt such as ‘Sub-layer's image and effect information, screen ratio of 16:9, position the sub-layer 1531 in front of the main layer, and display the sub-layer 1531 on the full screen for three seconds’.

The electronic device may display a preview image 1540 of the background layer. If a UI 1541 for displaying the background layer on the full screen is selected, the electronic device may display a main layer 1530 including a birthday cake object in a designated area of the execution screen of the message application, and may display a background layer 1551 including a scattering pollen object in the entire area of the execution screen of the message application.

The electronic device may display the background layer 1551 on the full screen by using a prompt such as ‘Background layer's image and effect information, screen ratio of 16:9, position it behind the main layer, and display it on the full screen for three seconds’.

FIG. 16 illustrates an operation in which an electronic device modifies a generated image according to an embodiment of the disclosure.

Referring to FIG. 16, the electronic device (e.g., the electronic device 101 in FIG. 1 or the processor 120 in FIG. 1) may provide a preview 1610 of a generated image. For example, the electronic device may display a preview image 1610 of the generated image, instead of multiple keys of the soft keyboard area.

Upon receiving a user input 1611 for regenerating the generated image, the electronic device may display a screen for modifying the generated image. The electronic device may display objects 1620 having different effects reflected with regard to respective layers (main/sub/background) through the screen for modifying the generated image. Upon receiving a user input for selecting an object having a different effect reflected through a swipe input 1621, the electronic device may modify the generated image by reflecting the selected object. A preview of the modified image may be included in an area of the screen for modifying the generated image, and the electronic device may provide the real-time image changed by selecting a layer-specific object.

FIG. 17 illustrates an operation in which an electronic device generates an image, based on an image selected by a user input according to an embodiment of the disclosure.

Referring to FIG. 17, the electronic device (e.g., the electronic device 101 in FIG. 1 or the processor 120 in FIG. 1) may provide keywords extracted based on conversation content and may display a screen for proposing image generation. Upon receiving a user input 1710 for selecting an image (e.g., a picture) through the screen for proposing image generation, the electronic device may display multiple images 1720 stored in the memory (e.g., the memory 130 in FIG. 1).

Upon receiving a user input for selecting an image 1721 among the multiple images 1721, the electronic device may redisplay the screen for proposing image generation.

Upon receiving a user input 1730 for generating an image through the screen for proposing image generation, the electronic device may display a preview 1740 of the generated image. The generated image may be the result of overlapping one image 1721 and a main layer, a sub-layer, and a background layer generated based on conversation content.

Upon receiving a user input 1741 for transmitting the generated image through the execution screen of the message application, the electronic device may display the generated image 1750 in an area of the execution screen of the message application.

As such, a personalized image may be generated by selecting the image to be applied to the main layer by a user input.

FIG. 18 illustrates an operation in which an electronic device modifies a generated image, based on an image selected by a user input according to an embodiment of the disclosure.

Referring to FIG. 18, the electronic device (e.g., the electronic device 101 in FIG. 1 or the processor 120 in FIG. 1) may provide a preview 1810 of a generated image. For example, the generated image may have been generated by an image extracted from multiple stored images, based on conversation content.

Upon receiving a user input 1811 for modifying the generated image, the electronic device may display a screen for modifying the generated image. The electronic device may display objects having different effects reflected with regard to respective layers (main/sub/background) through the screen for modifying the generated image.

Upon receiving a user input 1820 for selecting an image to be applied to the main layer on the screen for modifying the main layer of the generated image, the electronic device may display multiple images 1830 stored in the memory (e.g., the memory 130 in FIG. 1).

Upon receiving a user input for selecting one image 1831 of the plurality of images 1830, the electronic device may display a preview 1840 of an image generated based on the one selected image 1831. The generated image may be the result of overlapping one selected image 1831 and a main layer, a sub-layer, and a background layer generated based on conversation content.

Upon receiving a user input 1841 for transmitting the generated image 1840 through the execution screen of the message application, the electronic device may display the generated image 1850 in an area of the execution screen of the message application.

FIG. 19A illustrates an operation in which an electronic device generates an image, based on an image captured through a camera application, or a stored image according to an embodiment of the disclosure.

Referring to FIG. 19A, the electronic device (e.g., the electronic device 101 in FIG. 1 or the processor 120 in FIG. 1) may obtain an image, based on a user input 1911 for capturing a preview screen 1910 displayed through the execution screen of the camera application. The electronic device may display the captured image 1930 and may receive a user input 1931 for generating a sticker image by using generative AI, based on the captured image 1930.

If one image is selected through an execution screen of a gallery application in which multiple images are stored, the electronic device may magnify and display the one selected image 1920 and may display multiple function icons related to the one selected image 1920. Upon receiving a user input 1921 for selecting an icon for modifying the one selected image 1920 among the multiple function icons, the electronic device may display the selected image 1930 and may receive a user input 1931 for generating a sticker image by using generative AI, based on the selected image 1920. Operations after receiving the user input 1931 for generating a sticker image by using generative AI will be described in more detail with reference to FIG. 19B.

FIG. 19B illustrates an operation in which an electronic device generates an image, based on an image captured through a camera application, or a stored image according to an embodiment of the disclosure.

Referring to FIG. 19B, the electronic device may display a preview 1940 of a sticker image generated based on a captured or selected image. The electronic device may display a list 1941 which may be used to modify the effect of each layer of the generated sticker image. The list 1941 may be used to display multiple images having different effects applied to objects of respective layers, and a desired image may be selected from the multiple images through a swipe operation. If the effect is changed with regard to each layer, the changed effect may be reflected in real time on the preview 1940 of the generated sticker image.

Upon receiving a user input 1942 for generating a sticker image to which the selected effect is applied, after selection of the effect with regard to each layer is completed, the electronic device may display a preview 1950 of the finally generated image. Upon receiving a user input 1951 for ending the image generating operation, the electronic device may store the generated image in a depository as a sticker image 1960 related to the captured or selected image.

Upon receiving a user input 1971 for identifying the sticker image through the execution screen 1970 of the message application, the electronic device may display the sticker image 1972 stored in the depository. The electronic device may transmit the sticker image 1972 generated through the camera application or gallery application to the conversation counterpart through the execution screen 1970 of the message application.

According to an embodiment, an electronic device (e.g., the electronic device 101 in FIG. 1) may include memory (e.g., the memory 130 in FIG. 1), a display (e.g., the display 160 in FIG. 1), and a processor (e.g., the processor 120 in FIG. 1).

According to an embodiment, the memory may store instructions that, when executed by the processor, causes the electronic device to perform the following operations.

According to an embodiment, the instructions, when executed by the processor, may cause the electronic device to display an execution screen of a message application.

According to an embodiment, the instructions, when executed by the processor, may cause the electronic device to extract at least one keyword text, based on conversation information with history displayed through the execution screen.

According to an embodiment, the instructions, when executed by the processor, may cause the electronic device to, based on receiving a user input for generating an image displayable on the execution screen, identify an image corresponding to the at least one keyword text among a plurality of images stored in the memory.

According to an embodiment, the instructions, when executed by the processor, may cause the electronic device to obtain at least one first layer based on the identified image.

According to an embodiment, the instructions, when executed by the processor, may cause the electronic device to obtain at least one second layer based on at least one of the conversation information, the at least one keyword text, or information related to the identified image.

According to an embodiment, the instructions, when executed by the processor, may cause the electronic device to generate the image by overlapping the at least one first layer and the at least one second layer.

According to an embodiment, the information related to the identified image may include at least one of image analysis information of the identified image or meta information of the identified image.

According to an embodiment, the instructions, when executed by the processor, may cause the electronic device to determine the number of the at least one second layer, based on whether at least one of the image analysis information or the meta information is obtained.

According to an embodiment, the instructions, when executed by the processor, may cause the electronic device to determine whether to use at least one of an object included in the identified image or a background included in the identified image, based on at least one of the conversation information, the at least one keyword text, image analysis information of the identified image, or meta information of the identified image.

According to an embodiment, the instructions, when executed by the processor, may cause the electronic device to generate a main layer including the object, based on determining to use the object.

According to an embodiment, the instructions, when executed by the processor, may cause the electronic device to generate a background layer including the background, based on determining to use the background.

According to an embodiment, the instructions, when executed by the processor, may cause the electronic device to generate at least one of the at least one first layer or the at least one second layer by using generative AI.

According to an embodiment, the image may be a sticker image.

According to an embodiment, the instructions, when executed by the processor, may cause the electronic device to generate a prompt to be input to the generative AI, based on at least one of the conversation information, the at least one keyword text, image analysis information of the identified image, or meta information of the identified image.

According to an embodiment, the prompt may be generated by considering whether to include a motion effect in the sticker image.

According to an embodiment, the instructions, when executed by the processor, may cause the electronic device to obtain at least one of the at least one first layer or the at least one second layer as output data of the generative AI by using the prompt as input data of the generative AI.

According to an embodiment, the instructions, when executed by the processor, may cause the electronic device to identify an image selected by a user input among the plurality of images stored in the memory as the image corresponding to the at least one keyword text.

According to an embodiment, the instructions, when executed by the processor, may cause the electronic device to capture an image through a camera application.

According to an embodiment, the instructions, when executed by the processor, may cause the electronic device to identify the captured image as the image corresponding to the at least one keyword text.

According to an embodiment, the instructions, when executed by the processor, may cause the electronic device to determine the color of an object included in the at least one second layer, based on color information of the identified image.

According to an embodiment, the instructions, when executed by the processor, may cause the electronic device to, based on a user input for displaying the generated image, display a layer used as a background layer of the generated image among the at least one first layer and the at least one second layer, in an entire area of the execution screen.

According to an embodiment, the instructions, when executed by the processor, may cause the electronic device to display the generated image.

According to an embodiment, the instructions, when executed by the processor, may cause the electronic device to modify the generated image, based on a user input.

According to an embodiment, a method for controlling an electronic device may include an operation of displaying an execution screen of a message application.

According to an embodiment, a method for controlling an electronic device may include an operation of extracting at least one keyword text, based on conversation information with history displayed through the execution screen.

According to an embodiment, a method for controlling an electronic device may include an operation of, based on receiving a user input for generating an image displayable on the execution screen, identifying an image corresponding to the at least one keyword text among a plurality of images stored in memory of the electronic device.

According to an embodiment, a method for controlling an electronic device may include an operation of obtaining at least one first layer, based on the identified image.

According to an embodiment, a method for controlling an electronic device may include an operation of obtaining at least one second layer, based on at least one of the conversation information, the at least one keyword text, or information related to the identified image.

According to an embodiment, a method for controlling an electronic device may include an operation of generating the image by overlapping the at least one first layer and the at least one second layer.

According to an embodiment, the information related to the identified image may include at least one of image analysis information of the identified image or meta information of the identified image.

According to an embodiment, the operation of obtaining the second layer may further include an operation of determining the number of the at least one second layer, based on whether at least one of the image analysis information or the meta information is obtained.

According to an embodiment, the operation of obtaining at least one first layer may include an operation of determining whether to use at least one of an object included in the identified image or a background included in the identified image, based on at least one of the conversation information, the at least one keyword text, image analysis information of the identified image, or meta information of the identified image.

According to an embodiment, the operation of obtaining at least one first layer may include an operation of generating a main layer including the object, based on determining to use the object.

According to an embodiment, the operation of obtaining at least one first layer may include an operation of generating a background layer including the background, based on determining to use the background.

According to an embodiment, at least one of the operation of obtaining at least one first layer or the operation of obtaining at least one second layer may include an operation of generating at least one of the at least one first layer or the at least one second layer by using generative AI.

According to an embodiment, the image may be a sticker image.

According to an embodiment, at least one of the operation of obtaining at least one first layer or the operation of obtaining at least one second layer may include an operation of generating a prompt to be input to the generative AI, based on at least one of the conversation information, the at least one keyword text, image analysis information of the identified image, or meta information of the identified image.

According to an embodiment, the prompt may be generated by considering whether to include a motion effect in the sticker image.

According to an embodiment, at least one of the operation of obtaining at least one first layer or the operation of obtaining at least one second layer may include an operation of obtaining at least one of the at least one first layer or the at least one second layer as output data of the generative AI by using the prompt as input data of the generative AI.

According to an embodiment, the operation of identifying the image may include an operation of identifying an image selected by a user input among the plurality of images stored in the memory as the image corresponding to the at least one keyword text.

According to an embodiment, the operation of identifying the image may include an operation of capturing an image through a camera application.

According to an embodiment, the operation of identifying the image may include an operation of identifying the captured image as the image corresponding to the at least one keyword text.

According to an embodiment, the operation of obtaining at least one second layer may include an operation of determining the color of an object included in the at least one second layer, based on color information of the identified image.

According to an embodiment, the method for controlling an electronic device may further include an operation of, based on a user input for displaying the generated image, displaying a layer used as a background layer of the generated image among the at least one first layer and the at least one second layer, in an entire area of the execution screen.

According to an embodiment, the method for controlling an electronic device may further include an operation of displaying the generated image.

According to an embodiment, the method for controlling an electronic device may further include an operation of modifying the generated image, based on a user input.

According to an embodiment, in connection with a non-transitory computer-readable recording medium configured to store one or more programs, the one or more programs may include instructions that cause an electronic device to display an execution screen of a message application.

According to an embodiment, the one or more programs may include instructions that cause an electronic device to extract at least one keyword text, based on conversation information displayed through the execution screen.

According to an embodiment, the one or more programs may include instructions that cause an electronic device to, based on receiving a user input for generating an image displayable on the execution screen, identify an image corresponding to the at least one keyword text among a plurality of images stored in the memory.

According to an embodiment, the one or more programs may include instructions that cause an electronic device to obtain at least one first layer, based on the identified image.

According to an embodiment, the one or more programs may include instructions that cause an electronic device to obtain at least one second layer, based on at least one of the conversation information, the at least one keyword text, or information related to the identified image.

According to an embodiment, the one or more programs may include instructions that cause an electronic device to generate the image by overlapping the at least one first layer and the at least one second layer.

According to an embodiment, the information related to the identified image may include at least one of image analysis information of the identified image or meta information of the identified image.

According to an embodiment, the one or more programs may include instructions that cause an electronic device, when the electronic device is executed by the processor, to determine the number of the at least one second layer, based on whether at least one of the image analysis information or the meta information is obtained.

According to an embodiment, the one or more programs may include instructions that cause an electronic device, when the electronic device is executed by the processor, to determine whether to use at least one of an object included in the identified image or a background included in the identified image, based on at least one of the conversation information, the at least one keyword text, image analysis information of the identified image, or meta information of the identified image.

According to an embodiment, the one or more programs may include instructions that cause an electronic device, when the electronic device is executed by the processor, to generate a main layer including the object, based on determining to use the object.

According to an embodiment, the one or more programs may include instructions that cause an electronic device, when the electronic device is executed by the processor, to generate a background layer including the background, based on determining to use the background.

According to an embodiment, the one or more programs may include instructions that cause an electronic device, when the electronic device is executed by the processor, to generate at least one of the at least one first layer or the at least one second layer by using generative AI.

According to an embodiment, the image may be a sticker image.

According to an embodiment, the one or more programs may include instructions that cause an electronic device, when the electronic device is executed by the processor, to generate a prompt to be input to the generative AI, based on at least one of the conversation information, the at least one keyword text, image analysis information of the identified image, or meta information of the identified image.

According to an embodiment, the prompt may be generated by considering whether to include a motion effect in the sticker image.

According to an embodiment, the one or more programs may include instructions that cause an electronic device, when the electronic device is executed by the processor, to obtain at least one of the at least one first layer or the at least one second layer as output data of the generative AI by using the prompt as input data of the generative AI.

According to an embodiment, the one or more programs may include instructions that cause an electronic device, when the electronic device is executed by the processor, to identify an image selected by a user input among the plurality of images stored in the memory as the image corresponding to the at least one keyword text.

According to an embodiment, the one or more programs may include instructions that cause an electronic device, when the electronic device is executed by the processor, to capture an image through a camera application.

According to an embodiment, the one or more programs may include instructions that cause an electronic device, when the electronic device is executed by the processor, to identify the captured image as the image corresponding to the at least one keyword text.

According to an embodiment, the one or more programs may include instructions that cause an electronic device, when the electronic device is executed by the processor, to determine the color of an object included in the at least one second layer, based on color information of the identified image.

According to an embodiment, the one or more programs may include instructions that cause an electronic device, when the electronic device is executed by the processor, to, based on a user input for displaying the generated image, display a layer used as a background layer of the generated image among the at least one first layer and the at least one second layer, in an entire area of the execution screen.

According to an embodiment, the one or more programs may include instructions that cause an electronic device, when the electronic device is executed by the processor, to display the generated image.

According to an embodiment, the one or more programs may include instructions that cause an electronic device, when the electronic device is executed by the processor, to modify the generated image, based on a user input.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (A SIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory storing one or more computer programs;
a display;
one or more processors communicatively coupled to the memory and the display, and
wherein the one or more computer programs include computer-executable instructions that, when executed by the one or more processors individually or collectively, cause the electronic device to:
display an execution screen of a message application,
extract at least one keyword text based on conversation information with history displayed through the execution screen,
based on receiving a user input for generating an image displayable on the execution screen, identify an image corresponding to the at least one keyword text among a plurality of images stored in the memory,
obtain at least one first layer based on the identified image,
obtain at least one second layer based on at least one of the conversation information, the at least one keyword text, or information related to the identified image, and
generate the image by overlapping the at least one first layer and the at least one second layer.

2. The electronic device of claim 1,
wherein the information related to the identified image comprises at least one of image analysis information of the identified image or meta information of the identified image, and
wherein the one or more computer programs further include computer-executable instructions that, when executed by the one or more processors individually or collectively, cause the electronic device to:
determine a number of the at least one second layer based on whether at least one of the image analysis information or the meta information is obtained.

3. The electronic device of claim 1, wherein the one or more computer programs further include computer-executable instructions that, when executed by the one or more processors individually or collectively, cause the electronic device to:
determine whether to use at least one of an object included in the identified image or a background included in the identified image, based on at least one of the conversation information, the at least one keyword text, image analysis information of the identified image, or meta information of the identified image,
generate a main layer including the object based on determining to use the object included in the identified image, and
generate a background layer including the background based on determining to use the background included in the identified image.

4. The electronic device of claim 1, wherein the one or more computer programs further include computer-executable instructions that, when executed by the one or more processors individually or collectively, cause the electronic device to:
generate at least one of the at least one first layer or the at least one second layer using generative artificial intelligence (AI).

5. The electronic device of claim 4,
wherein the image is a sticker image,
wherein the one or more computer programs further include computer-executable instructions that, when executed by the one or more processors individually or collectively, cause the electronic device to:
generate a prompt to be input to the generative AI, based on at least one of the conversation information, the keyword text, image analysis information of the image, or meta information of the image, and
obtain at least one of the at least one first layer or the at least one second layer as output data of the generative AI by using the prompt as input data of the generative AI, and
wherein the prompt is generated considering whether to include a motion effect in the sticker image.

6. The electronic device of claim 1, wherein the one or more computer programs further include computer-executable instructions that, when executed by the one or more processors individually or collectively, cause the electronic device to:
identify an image selected by a user input among the plurality of images stored in the memory as the image corresponding to the at least one keyword text.

7. The electronic device of claim 1, wherein the one or more computer programs further include computer-executable instructions that, when executed by the one or more processors individually or collectively, cause the electronic device to:
capture images through a camera application, and
identify the captured image as the image corresponding to the at least one keyword text.

8. The electronic device of claim 1, wherein the one or more computer programs further include computer-executable instructions that, when executed by the one or more processors individually or collectively, cause the electronic device to:
determine a color of an object included in the at least one second layer based on color information of the identified image.

9. The electronic device of claim 1, wherein the one or more computer programs further include computer-executable instructions that, when executed by the one or more processors individually or collectively, cause the electronic device to:
based on a user input for displaying the generated image, display a layer used as a background layer of the generated image among the at least one first layer and the at least one second layer, in an entire area of the execution screen.

10. The electronic device of claim 1, wherein the one or more computer programs further include computer-executable instructions that, when executed by the one or more processors individually or collectively, cause the electronic device to:
display the generated image, and
modify the generated image based on a user input.

11. A method for controlling an electronic device, the method comprising:
displaying an execution screen of a message application;
extracting at least one keyword text based on conversation information with history displayed through the execution screen;
based on receiving a user input for generating an image displayable on the execution screen, identifying an image corresponding to the at least one keyword text among a plurality of images stored in memory of the electronic device;
obtaining at least one first layer based on the identified image;
obtaining at least one second layer based on at least one of the conversation information, the at least one keyword text, or information related to the identified image; and
generating the image by overlapping the at least one first layer and the at least one second layer.

12. The method of claim 11,
wherein the information related to the identified image comprises at least one of image analysis information of the identified image or meta information of the identified image, and
wherein the obtaining of the second layer comprises determining a number of the at least one second layer, based on whether at least one of the image analysis information or the meta information is obtained.

13. The method of claim 11, wherein the obtaining of the at least one first layer comprises:
determining whether to use at least one of an object included in the identified image or a background included in the identified image, based on at least one of the conversation information, the at least one keyword text, image analysis information of the identified image, or meta information of the identified image;
generating a main layer including the object, based on determining to use the object included in the identified image; and
generating a background layer including the background, based on determining to use the background included in the identified image.

14. The method of claim 11, wherein at least one of the obtaining of the at least one first layer or the obtaining of the at least one second layer comprises generating at least one of the at least one first layer or the at least one second layer by using generative artificial intelligence (AI).

15. The method of claim 14,
wherein the image is a sticker image,
wherein at least one of the obtaining of the at least one first layer or the obtaining of the at least one second layer comprises:
generating a prompt to be input to the generative AI, based on at least one of the conversation information, the at least one keyword text, image analysis information of the identified image, or meta information of the identified image; and
obtaining at least one of the at least one first layer or the at least one second layer as output data of the generative AI by using the prompt as input data of the generative AI, and
wherein the prompt is generated by considering whether to include a motion effect in the sticker image.

16. The method of claim 11, wherein the identifying of the image comprises identifying an image selected by a user input among the plurality of images stored in the memory as the image corresponding to the at least one keyword text.

17. The method of claim 11, wherein the identifying of the image comprises:
capturing an image through a camera application; and
identifying the captured image as the image corresponding to the at least one keyword text.

18. The method of claim 11, wherein the obtaining of the at least one second layer comprises determining a color of an object included in the at least one second layer, based on color information of the identified image.

19. The method of claim 11, further comprising, based on a user input for displaying the generated image, displaying a layer used as a background layer of the generated image among the at least one first layer and the at least one second layer, in an entire area of the execution screen.

20. One or more non-transitory computer-readable recording media storing one or more computer programs including computer-executable instructions that, when executed by one or more processors of an electronic device individually or collectively, cause the electronic device to perform operations, the operations comprising:
displaying an execution screen of a message application;
extracting at least one keyword text based on conversation information displayed through the execution screen;
based on receiving a user input for generating an image displayable on the execution screen, identifying an image corresponding to the at least one keyword text among a plurality of images stored in memory of the electronic device;
obtaining at least one first layer based on the identified image;
obtaining at least one second layer based on at least one of the conversation information, the at least one keyword text, or information related to the identified image; and
generating the image by overlapping the at least one first layer and the at least one second layer.
